(19) United States
(12) Patent Application Publication
(10) Pub. No.: US 2016/0224869 A1
(43) Pub. Date: Aug. 4, 2016

(54) Correlation Of Visual and Vocal Features To Likely Character Trait Perception By Third Parties

(71) Applicant: Elizabeth Clark-Polner, New Haven, CT (US)

(72) Inventor: Elizabeth Clark-Polner, New Haven, CT (US)

(73) Assignee: NONE

(21) Appl. No.: 15/010,950

(22) Filed: Jan. 29, 2016

Related U.S. Application Data
(60) Provisional application No. 62/109,420, filed on Jan. 29, 2015.

(51) Int. Cl. G06K 9/62; G06F 3/01; G06K 9/00

(52) U.S. Cl. CPC G06K 9/6254; G06K 9/6257; G06K 9/6265; G06K 9/627; G06K 9/6277; G06K 9/00288; G06F 3/013; G06F 3/015

(57) ABSTRACT

A system and method are provided for associating initial perceptions of viewed images with visual or audible features such as facial features or vocal features and then comparing selected images or content to those visual or vocal features to predict a likely initial perception of those selected images or content or to allow for the selection of a desired perception and then selection of one or more images or content from a collection of images or content that is most likely to be associated with the selected perception. A system is also provided for generating an image combining features of more than one image to increase the likelihood of a selected perception.

### FIELD OF THE INVENTION

The following invention involves systems and methods for determining relationships between the way in which an individual or entity looks or sounds, and a third party's initial or likely perception of that individual or entity, in terms of the character or aesthetic traits it possesses. More particularly, the invention relates to determining how facial features, other visual features, or voice sounds relate to the likelihood of a particular emotional or behavioral response, or character trait perception, by a third party. The invention also involves system and methods for the use of these relationships between visual and vocal features and likely third party perceptions to allow individuals or entities to optimize the impression that they make on other people.

### BACKGROUND OF THE INVENTION

In the internet age, first impressions are now more frequently made online, rather than in person. Although many individuals hope that they are able to reserve judgement of someone's character traits until they interact with, and get to know that person, a growing literature now demonstrates that first impressions may bias our behavior towards others in ways both powerful and uncontrollable.

Indeed, research has demonstrated that the way you look and sound can have a profound impact on how others view you, and how they behave with respect to you, in both personal and professional settings. Indeed, the impact of first impressions is realized quickly and unconsciously, and these impressions influence any subsequent information one might learn about you, making them extremely difficult to counteract or correct, after the fact. Making the right first impression is thus integral to achieving successful social and business interactions.

The conventional approach to improving or optimizing one's public impression is to evaluate one's appearance oneself. This solution provides little utility, however. Research has demonstrated that individuals are extremely biased in their evaluations of their own appearance, seeing themselves more in line with how they desire to look, than with how they actually look, in reality. An alternative approach that is also common is to ask one's family members or friends for their opinions. This strategy represents a marginal improvement in terms of accuracy (measured in terms of how similar a person's judgment is to the judgment that would be made by a third party, who has never met you before) relative to judgments made by oneself, but it is still problematic, because research has demonstrated that close others —including family and friends—are still very likely to be biased in their predictions of how others (strangers) will view you, by nature of their prior knowledge of and existing relationship with you. Neither you, nor the people to whom you are most likely to reach out for help, are therefore able to provide accurate predictions of how a stranger will evaluate you, having just met you for the first time.

It is also notable that both approaches described above—making evaluations oneself, and having close others make them for you—are flawed not only because the evaluators are inherently biased, but also because any one judgment is likely to be statistically inaccurate. Research has demonstrated that there is significant variation in one's judgments, even of the same content. More specifically, each judgment reflects both one's true opinion, plus error variance (due to, for example, contextual or background factors, like distraction or fatigue).

As one example of the power of initial impressions, we have used information from prison inmates' applications for parole and have determined that snap judgments, based solely on appearance, exert a measurable influence on behavior, even in the context of processes and precautions specifically designed to ensure data-driven and impersonal evaluations. Indeed, this effect is sufficiently large and reliable that the outcome of a prisoner's parole hearing may be predicted based solely on the brain activity of a naïve participant, looking at the prisoner's picture. Our findings suggest that even our most important and deliberative decisions can be swayed by extraneous variables, like appearance.

The applications of this finding is much larger than just legal decisions, however. On a daily basis, social media photos, LinkedIn® pages and Facebook® pages are viewed, and initial perceptions are made based on these pages and photos. Similarly, many businesses use websites and social media to market to prospective customers. In both cases, the way in which the content to be posted online is chosen does not effectively account for the impact that this content has on other individuals' or customers' beliefs and behaviors.

For example, the CEO of a tech company may want their profile photo to result in an impression that this individual is intelligent. An attorney may want their profile photo go give an impression of trustworthiness, and a doctor may want to appear skilled or experienced. Along the same lines, a startup may want its name or its logo to leave viewers with the impression that it is creative or innovative. Unfortunately, the individual choosing which photo to post, or the founder deciding which name and logo to adopt, may not have a reliable way to make an educated choice, using his or her judgment alone.

The system and method described here may be distinguished from other, extant, systems and methods in multiple ways. First, the primary aim of this system and method is not recognition or classification of objects, but rather prediction of the inferences that people make, based on those objects, or their evaluations of those objects. In other words, whereas existing software implemented into various services is designed to identify objects—e.g. “is this a person or a chair?”—this system and method is designed to identify what people are likely to think of entities—e.g. “does this person look intelligent?”. As a result, wherein other systems and methods produce results in the form of various nouns (“will a person looking at this see a woman, or a tree?”), this system and method are designed to predict which adjectives (“will a person looking at this think this woman is beautiful?”) and behaviors (“will a person looking at this remember this woman for more than a few seconds?”) are likely to be associated with different content.

The system and method described here also differ from existing systems and methods that utilize neural networks and artificial intelligence in their likely applications. Whereas systems and methods for identifying and classifying objects are used in computer vision to allow, for example, robots to navigate their environment, this system and method have a primarily social application, and may be used to help individuals' manage their first impressions on others in a way that cannot be done through the traditional techniques of asking for advice from friends as discussed further herein.

The system and method described herein also differ from other social applications in their use of computer vision—and more specifically deep neural networks—to achieve their aim, and by focusing specifically on first impressions.

Finally, the system and method described here differ from applications that aim to predict a person's emotional state or character traits based on his or her appearance. In contrast, this system and method seek to predict what other individuals will believe a person's state or trait characteristics are. This is an important distinction. Whereas research has demonstrated that there is little to no relationship between the way a person looks, and the way in which he or she behaves or feels, there is a significant relationship between the way in which a person looks or sounds, and the way in which other people think he or she will behave or feel. In contrast to other applications, this system and method are designed to predict these third party beliefs.

Accordingly, there is a need for a method and service for providing more accurate, precise, reliable, and storable information for users to understand and manage the first impressions that they or their organization make on others.

### SUMMARY OF THE INVENTION

One object of the invention described here is to provide a system and method for predicting the inferences that human viewers or listeners will make about an entity, based on how it is portrayed in an image or a sound. The invention achieves this by building and utilizing a neural network, trained on a large and heterogeneous set of images and recordings, along with ratings of the entities (people and organizations) portrayed in those images and recordings along a number of different personality and physical characteristics (e.g. trustworthiness; intelligence; age; attractiveness). This neural network, once trained, can be used to make predictions about how novel content—submitted by a user—is likely to be perceived by others. For example, an individual may input two photographs of him or herself, with the proximal goal of better understanding the character traits that those photographs are likely to project, and with the ultimate purpose of selecting from those two image options the best photograph to feature on his or her resume or social networking profile.

It is another object of the present invention to provide a system and method for gathering data relating to viewers' judgments of perceptual content (including visual, auditory, and semantic information)

It is another object to decompose perceptual content into its most basic features, and to use this to determine whether relationships exist between viewers' judgments and these basic perceptual features, and characterizing those relationships, where they exist.

It is another object of the present invention to provide a system and method for making predictions as to how a viewer would likely react to novel content, based solely on the combination of features that it contains, and known relationships between those features and third party perceptions. The system will further provide suggestions as to alternate audio, visual, or semantic content to use based on the specific type of perception that a user wants to optimize (from amongst the pool of content provided by the user), or allow the user to make modifications to a specific piece of content, by adding features that are known to be related to the perception that the user would like others to make. Finally, the system will allow users to up-load images that they have selected or synthesized directly to other digital devices and services.

It is another object to provide a method and system for gathering data on initial impressions to determine how an individual's features such as facial features or vocal features relate to an impression by third party viewers.

It is yet another object of the invention to provide a method and system for using data on these initial impressions to provide meaningful guidance on which photographs are likely to result in particular desired impressions.

It is yet another object of the invention to provide a method and system for selecting features from multiple photographs and combining those features into a single computer generate photograph that provides the desired impressions.

These and other objects are achieved by providing a system and method that associates initial perceptions of viewed images with visual features such as facial features and then comparing selected images to those visual features to predict a likely initial perception of those selected images or to allow for the selection of a desired perception and then selection of one or more images from a collection of images that is most likely to be associated with the selected perception. A system is also provided for generating an image combining features of more than one image to increase the likelihood of a selected perception.

The following definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The terms “user” or “users” mean a person or persons, respectively, who access media data in any manner, whether alone or in one or more groups, whether in the same or various places, and whether at the same time or at various different times.

The term “network connection” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, media, components, network connections, systems, subsystems, and/or means, constituting any one or more of (a) a connection, whether direct or through one or more other devices, apparatus, files, programs, media, components, network connections, systems, subsystems, or means, (b) a communications relationship, whether direct or through one or more other devices, apparatus, files, programs, media, components, network connections, systems, subsystems, or means, and/or (c) a functional relationship in which the operation of any one or more devices, apparatus, files, programs, media, components, network connections, systems, subsystems, or means depends, in whole or in part, on the operation of any one or more others thereof.

The terms “process” and “processing” as used herein each mean an action or a series of actions including, for example, but not limited to, the continuous or non-continuous, synchronous or asynchronous, routing of data, modification of data, formatting and/or conversion of data, tagging or annotation of data, measurement, comparison and/or review of data, and may or may not comprise a program.

In one aspect a method is provided for relating visual features to a perception by an observer of subjects having the same or similar features. The method includes the steps of: providing a computer in communication with a display, a response device, an imaging device and a storage; displaying at least a first one of a plurality of images via the display to a viewer, each image corresponding to one of a plurality of subjects; receiving a response via a response device from the viewer to the at least a first one of the plurality of images wherein the response is indicative of at least a first or a second response to the at least a first one of the plurality of images; recording via the imaging device at least one focus region of the viewer on the displayed image and correlating the at least one focus region with a visual feature of the subject; and generating a data set via the computer and storing said data set on said storage, the data set creating an association between the visual feature and the response to indicate a likely perception based on the visual feature.

The association can be a statistical correlation. The visual features may be facial features of the subject. The imaging device may determine the at least one focus region by tracking eye movement of the viewer between initial display of each image and receipt of the response and may associate the eye movement with at least one location for each of the plurality of images.

The method may further include providing a neuro-imaging scanner in communication with the computer which transmits neuro-imaging data of the viewer. The neuro-imaging data is indicative of a neurological response of the viewer between initial display of the at least a first one of the plurality of images and receipt of the response. The step of generating the data set may further include associating the neurological response with the focus region and the visual feature.

The first response may be indicative of a positive perception and the second response is indicative of a negative perception.

The first response is selected from the group consisting of: trustworthy, honest, focused, strong, creative, and combinations thereof and the second response is a negative of the first response.

The method may include repeating the displaying, receiving and recording steps for successive ones of the plurality of images. The generating step further associates the visual feature with the likely perception based on a statistical correlation of the responses to the successive ones of the plurality of images to generate the data set.

In another aspect a system is provided for determining a likely perception of a subject based on an image of the subject. A computer is in communication with a storage, the storage has data stored thereon, the data providing an association between at least one visual feature and a perception. Software executes on the computer and receives an image of the subject and determines a subject feature by comparing the image to the visual feature. The software associates the subject feature with the visual feature based on a match where the match is indicative of the subject feature matching the visual feature. A display is coupled to the computer and presents the perception associated with the at least one visual feature based on the at least one subject facial feature being associated therewith.

The visual feature and the at least one feature may both be facial features. The perception presented via the display may be indicative of a likelihood that a third party viewing the image would have the perception upon viewing the image. The subject feature may be determined by identification of an area of the at least one image corresponding to a face and comparing parts of the area to known images corresponding to control features, where the parts of the area are matched to the control features that are associated with control images and the parts of the area are matched based on a coloring or shape or combinations thereof to determine the match.

The parts of the area may be matched to the control features based on a percentage of similarity or a percentage in relation to two control features having different intensity of the control features to determine the match.

The match between the at least one visual feature and the at least one subject feature may be expressed as a similarity which may further be a percentage.

In one aspect, a system is provided for selecting one or more images based on a desired perception. A computer is in communication with a storage, the storage having data stored thereon, the data indicative of an association between at least one visual feature and a perception. Software executes on the computer and receives a plurality of images of a subject and a selection of a selected perception. The software further determines at least one subject feature for each of the plurality of images and associates at least one subject feature with the at least one visual feature to determine a perception for one or more of the plurality of images. The software further determines which of the one or more of the plurality of images is most likely to be associated with the selected perception to determine at least one likely image. A display is coupled to the computer and presents the at least one likely image.

The at least one likely image may be a ranking of multiple images. The at least one likely image may be presented as the group consisting of: an image, file name, file path, or combinations thereof, that is most likely to be associated with the selected perception.

The association between the visual feature and the perception may be based on a set of data gathered by displaying a plurality of images to a plurality of viewers wherein upon display of each of the plurality of images, one of the plurality of viewers indicates at least a first or second response, the response associated with an initial perception and the data correlates a plurality of responses to the plurality of images with focus region such that the focus region is associated with the visual feature.

In one aspect a system is provided for producing an image associated with likely perceptions. A computer is in communication with a storage having data stored thereon, the data associating a visual feature of a subject with a perception. Software executes on the computer for receiving a selected perception. The software receives a plurality of images and determines at least two perceptions associated with each image based on two visual features. The software selects a first one of the plurality of images having the selected perception as the most likely perception among the plurality of images based on a first one of the two visual features. The software compares a second one of the two visual features to the selected perception to determine if the second one of the two visual features conflicts or undermines the selected perception such that the selected perception is less likely. The software selects part of at least one of the plurality of images, where the part of the at least one of the plurality of images increases the likelihood of the selected perception. The software overlays the part of the at least one of the plurality of images over a part of the first one of the plurality of images to create a combined image.

The software further blends the part of the at least one of the plurality of images with the first one of the plurality of images by modifying a color or a shading or a lighting effect of the combined image to increase the likelihood of the selected perception.

In another aspect a method is provided for relating content features to a perception by an observer of subjects having the same or similar content features. The method includes the steps of: providing a computer in communication with a presentation device, a response device, and a storage; presenting a first one of a plurality of content segments via the presentation device to a responder, each content segment corresponding to one of a plurality of subjects; receiving a response via a response device from the responder to the at least a first one of the plurality of content segments the response is indicative of a degree to which the responder perceives a specified perception; repeating the presenting and receiving steps for each of the plurality of content segments; generating a dataset associating each of the plurality of content segments with the responder's response; identifying a pattern based on the dataset to associate a feature of the plurality of content segments with the specified perception; and comparing the feature with a user content segment to determine the likelihood of the specified perception for the user content segment based on the dataset.

The plurality of content segments may be selected from the group consisting of an: image, sound, video or combinations thereof.

Other objects of the invention and its particular features and advantages will become more apparent from consideration of the following drawings and accompanying detailed description.

### BRIEF DESCRIPTION OF THE DRAWINGS

FIG. 1 is a functional flow diagram showing how a relationship is determined between visual features and perceptions of individuals having those features

FIG. 2 is a functional flow diagram showing how the relationship of FIG. 5 is used to predict perceptions.

FIG. 3 is a functional flow diagram showing additional detail of FIG. 2 according to one embodiment.

FIGS. 4A-B are functional flow diagrams showing additional detail of FIG. 2 according to additional embodiments.

FIG. 5A-E represents the process and results of Experiment 1 described herein.

FIG. 6 A-D represents the results from a neuroimaging study conducted using the apparatus of FIG. 1.

FIG. 7 A-C represents results from another neuroimaging study conducted using the apparatus of FIG. 1.

FIG. 8A-C represents the process and results of Experiment 6 described herein.

FIG. 9A-B represents Experiment 5 described herein.

FIG. 10 shows a number of screen shots of the user interface of FIG. 1.

FIG. 11 represents action units identified having a significant relationship to perceived trustworthiness (See Table S3).

FIG. 12 is an exemplary functional flow diagram of the application shown in FIG. 10.

### DETAILED DESCRIPTION OF THE INVENTION

In various implementations, the system and method described herein combines theoretical model-based and data-driven hybrid architecture for analyzing image, sound, or semantic content, and making predictions based on that analysis. The model-based portion of the analysis pipeline is based on psychological and neuroscientific research describing the types of inferences individuals are most likely to make regarding other people or entities, and the types of inferences that are most likely to influence their behavior, with respect to those people or entities (and thus which the people or entities would be most interested in predicting). The data-driven portion of pipeline is utilized for learning image, auditory, or semantic features from simple to complex in a progressive fashion, relating those features to data describing the inferences that people made based on the original content, and then utilizing those learned relationships to make predictions as to likely inferences based on new content, submitted by the user.

In various implementations, this model-based and data-driven hybrid algorithm for analyzing content is developed according to the following three steps or procedures:

Data Collection.

The goal of this step is to gather the raw data necessary to train the neural network. These data include both content (photographs, recordings, text), as well as data that indicate how viewers perceived that content. These data can be collected in two ways. First, an individual may gather content, and explicitly solicit judgments from viewers. For example, one may identify a set of images of people, and then submit these images to a set of human raters, whose task it is to look at each image, and then to indicate for each image the degree to which the person portrayed appears to them to hold designated characteristics (e.g. intelligence). Data that indicate how viewers perceived visual, auditory, or semantic content can also be collected indirectly, by looking at observable behaviors that are likely to be correlated with specific types of judgments. For example, one could collect a set of images from an online social media sharing service, and use the data as to how many “likes” those images received, or how many times they were shared, as an indirect indication of the degree to which viewers found the content to be appealing. The types of content that are evaluated include, but are not limited to, visual (photographs; avatars; logos), auditory (vocal recordings); and semantic (resumes; biographical text). The types of data that are collected regarding likely viewer judgments of the people or entities featured in this content include but are not limited to judgments about apparent competence, intelligence, leadership, honesty, trustworthiness, charisma, likability, kindness, dependability, confidence, popularity, prestige, attractiveness, age, gender, and memorability. The ways in which these data are collected include but are not limited to the explicit solicitation of viewer beliefs along a specified dimension (e.g. “how trustworthy does the person in this photograph look?”), and the collection of data regarding behaviors that indirectly reflect viewer judgments online, including from internet search engines and online social media or networking websites.

Model Training.

The second step after content and data collection is model training. The system and method described here build on machine learning, and include (but are not limited to) the use of deep convolutional neural networks as a machine learning methodology. In various implementations, the process for training the neural network may use both supervised and unsupervised learning, depending on the size of the available dataset, and may comprise a varying number of layers, which may be both convolutional and fully connected, depending on the nature of the content submitted to the model and the types of likely perceived traits that the user desires to predict. All new datasets to which the model is applied may be divided into two subsets, with the model to be trained on one, and tested on the other, so as to allow for an estimation of the accuracy of the neural net in predicting the perceived traits contained in the dataset, upon the basis of the type of content submitted. In training the model, the weights in each layer are initialized from a zero-mean Gaussian distribution. The selection of which type of neural network to use, and the number of layers to be included, is to be determined based on iterative testing of different neural networks. During this testing, the number and nature of layers (convolutional versus fully connected) is to be varied, and the accuracy of the model in predicting likely perceptions (within the training set) is to be recorded, along with each variation. The parameters that produce the greatest accuracy are those which are to be used for the final version of the model, made available to users for this particular content (e.g. photographs; avatars; audio recordings; text) and likely perception (e.g. honesty) pair.

User Interface Implementation.

Once the model has been trained, the user interface may be developed. In this final step, the trained neural network is combined with auxiliary algorithms that allow for the efficient use of the network, to achieve the user's goals. In particular, the neural network may be paired with a secondary network, the purpose of which is to recognize the presence (or lack thereof) of the type of content that the model is designed to evaluate. For example, if the model is trained on faces and is designed to predict likely perceptions of character traits (e.g. kindness), the secondary model would be used to detect the presence or absence of a face in the picture. This network, in contrast to the primary network, is a classification model (with categorical outcomes) rather than a regression model (with outcomes indicated in degrees). If this secondary model is not satisfied—if, for example, no face is present in the picture—than an error message will be returned to the user, and the primary model will not be engaged. Similar to the primary (regression) model, the secondary (classification) model utilizes a deep learning neural network, with the number of layers and the type of layers utilized to be determined according to the iterative method described above (i.e. testing both convolutional and fully connected layers, and testing a range of different numbers of these layers, and selecting the final parameters based on the type/number combination that produces the greatest accuracy within the test set).

From the users' perspective, one embodiment of the system and method for predicting likely perceptions comprises seven steps: (1) Submitting content. First, the user must select novel content to be submitted to the neural network. This content may be visual, auditory, or semantic (text). The user must also indicate at this step the dimensions along which the content is to be rated (e.g. perceived trustworthiness).

(2) Evaluation of Content.

Once the user has designated that content which is to be evaluated, the content is submitted to the neural network. In various implementations, the neural network may be hosted locally, on the client's device, or may be hosted remotely. In the case that the network is hosted remotely, the content (e.g. an image) is transmitted to the remote server, and the results are returned, via internet connection. If the secondary (classification) algorithm detects that the content that is submitted does not match that which is required for the analysis (for example, a photograph which does not include any people is submitted to a neural net designed to evaluate likely perceptions based on faces), and error message will be returned to the user, instead of a results display.

(3) Return of Results.

At this step, the results of the analysis are displayed to the user. These results are displayed in terms of the percentage likelihood that a stranger, viewing, hearing, or reading the specified content, will perceive the person or entity that the content describes as having the specified trait. Results may also be displayed in terms of how much of a trait (e.g. beauty) the person or the entity appears to hold.

(4) Storage of Data.

After analyzing content, the user will have the option to store both the content, and the results of the analysis, for later Use.

(5) Manipulation of Content.

After analyzing content, the user will also have the option to manipulate that content, in order to achieve a desired perception. For example, if a user submitted an image of him or herself to be evaluated for perceived trustworthiness, the user would then have the option to modify that image, so as to increase (or decrease) the degree to which he or she is perceived as trustworthy (while leaving unmodified other attributes, such as age and gender). If this option is selected, this would be achieved by first examining the features identified by the neural network trained according to the method described above, and then second, implementing a cost function, and iterating through these features, in a such a way that we can identify those features that allow us to achieve the greatest modification of the specified trait (e.g. perceived trustworthiness) with the least change to other features, including the identify of the person or entity described in the content. This cost function would consist of three terms: 1) the cost of modifying the identify of the person or entity described in the content; 2) the cost of not modifying trait that one desires to modify (e.g. perceived trustworthiness); and 3) the cost of modifying all the other traits that the person or entity appears to hold (e.g. intelligence or beauty). Minimizing this cost function allows us to identify the features to be modified. These features, once identified, can then be layered onto, or subtracted from, the content (e.g. a photograph) in order to achieve the desired perception. The success of the modification of the content in terms of making more likely the desired perception can be tested by submitting it again to the original neural network, and comparing the regression results.

(6) Retrieval of Stored Data.

If the user has elected to store his or her previously evaluated content, that content will remain available to the user, for later use—either to be posted to other platforms (see below), or to be compared to new content, as it is evaluated. This feature, for example, would allow a user to go back and identify from all the images of him or herself that he or she has ever evaluated that in which he or she looks the most attractive.

(7) Distribution or Posting of Content.

Finally, the system and method described here also allow for a user to share content that he or she has evaluated and/or modified, with others, using existing internet and social media platforms. The user interface allows for this by incorporating links into these services within the user interface, such that users may post (for example) a photograph or recording that they have evaluated directly to those other, outside, platforms without leaving the application.

The user interface, as described here, may be implemented in various forms, including a mobile application, an internet application, a client-side software application, or as code integrated into third-party software or services.

Referring now to the drawings, wherein like reference numerals designate corresponding structure throughout the views. The following examples are presented to further illustrate and explain the present invention and should not be taken as limiting in any regard. It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

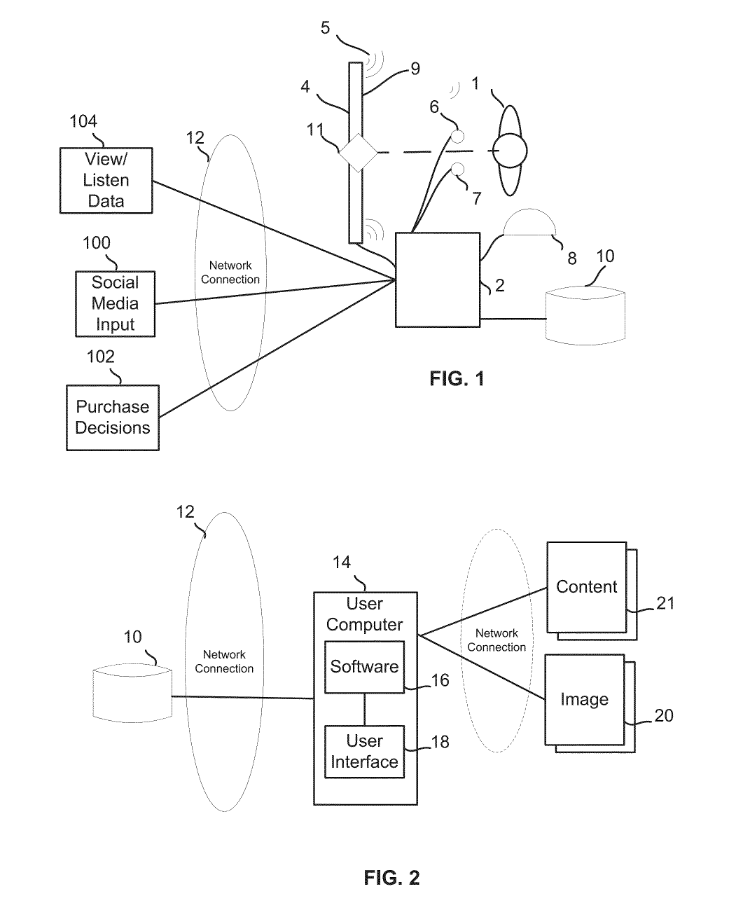

FIGS. 1 and 2 show computer 2 is connected to response device 6, 7, presentation device 4 which includes a display 9 and speakers 5, storage 10, and neuroimaging device/sensor 8. Imaging device 11 may be used to determine where on the displayed image the viewer 1 is focusing between display of the image and selection of response device 6 or 7. Device 6 may be associated with a “positive” response and device 7 may be associated with a “negative” response. For example Trustworthy and Not Trustworthy. Images may be sequentially displayed on the display 9 and the response, neuroimaging data from the neuroimaging device 8, response time and location on the display may be recorded and stored to identify the focus region of the image that the viewer 1 focuses on in entering the response. Analysis discussed herein may be performed on this data to determine what facial features are associated with which responses. The imaging device 11 tracks eye movement and/or pupil dilation to determine what particular areas or points on the displayed image the viewer 1 focuses on before entering the response via devices 6/7. In addition, user reactions of visual or audio content can be determined by internet records of user behavior. For example, social media interaction 100, purchase decisions 102 or view data 104 can be compiled to augment or modify the associations between visual or audible features and perceptions. The social media interaction may be “liking” a particular part of content. The purchase decision may be a decision to purchase an item such as clothing or others based on the marketing image or content of an advertisement. View data 104 may indicate the number of times a particular user views certain content or how long they dwell on content in order to determine what catches the attention of individuals when browsing online content.

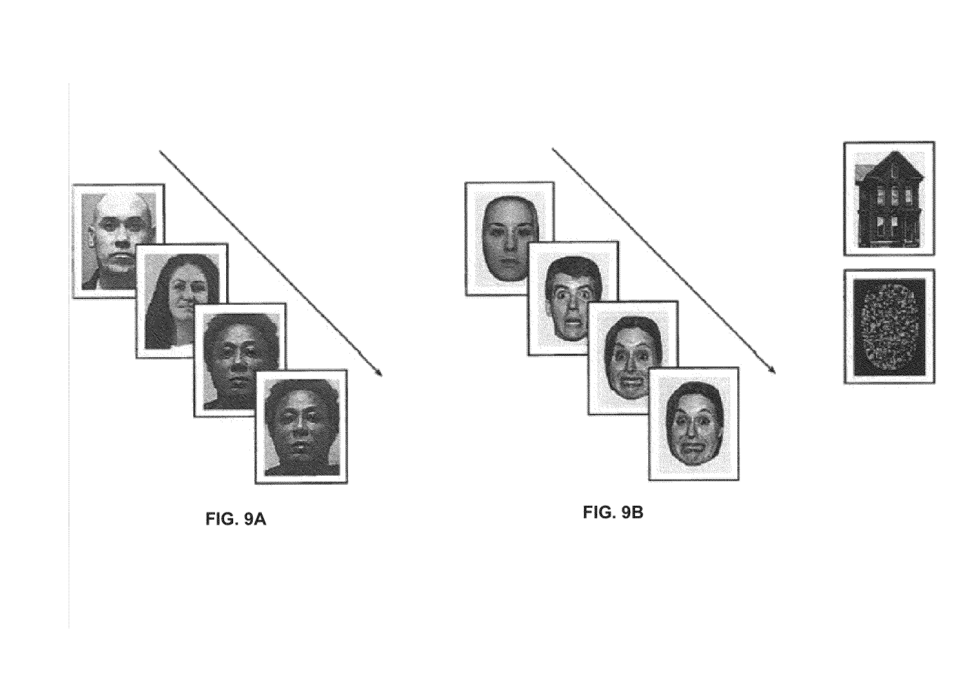

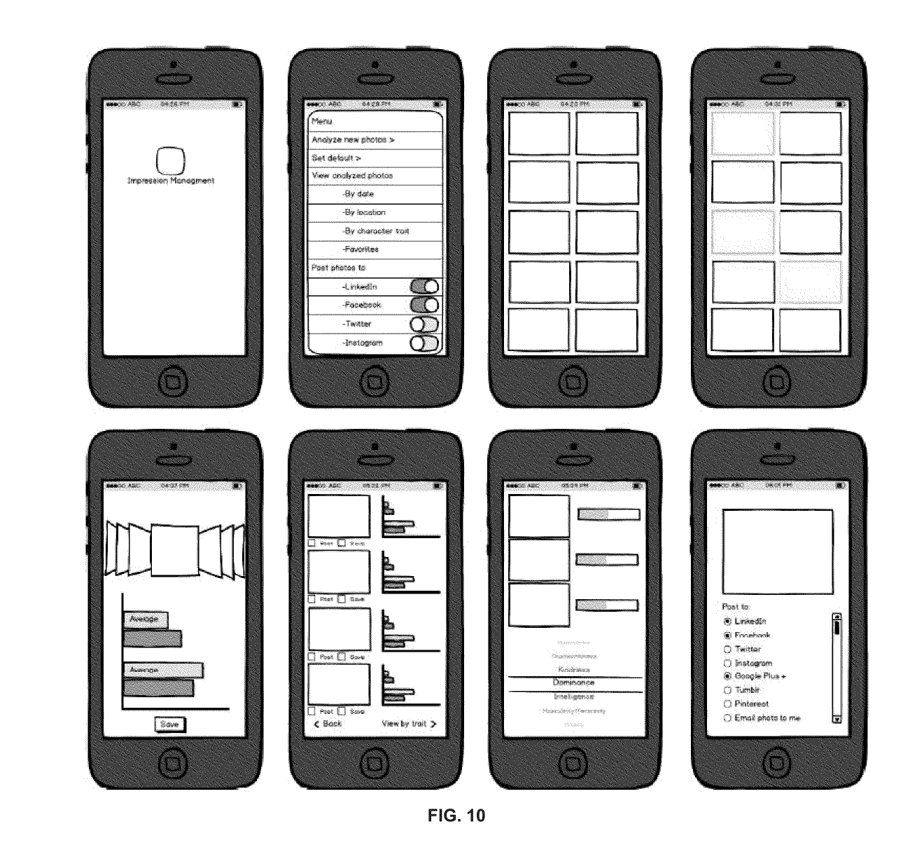

The data stored in the storage 10 may be used or accessed by a user computer 14 over a network connection 12 (which may be optional). The software 16 receives an image 20 (the image may be local to the user computer or uploaded). The user interface 18 is used to display various perceptions contemplated herein. One exemplary user interface is shown in FIG. 10. It is understood that the user computer may be a mobile device such as a smart phone or tablet computer.

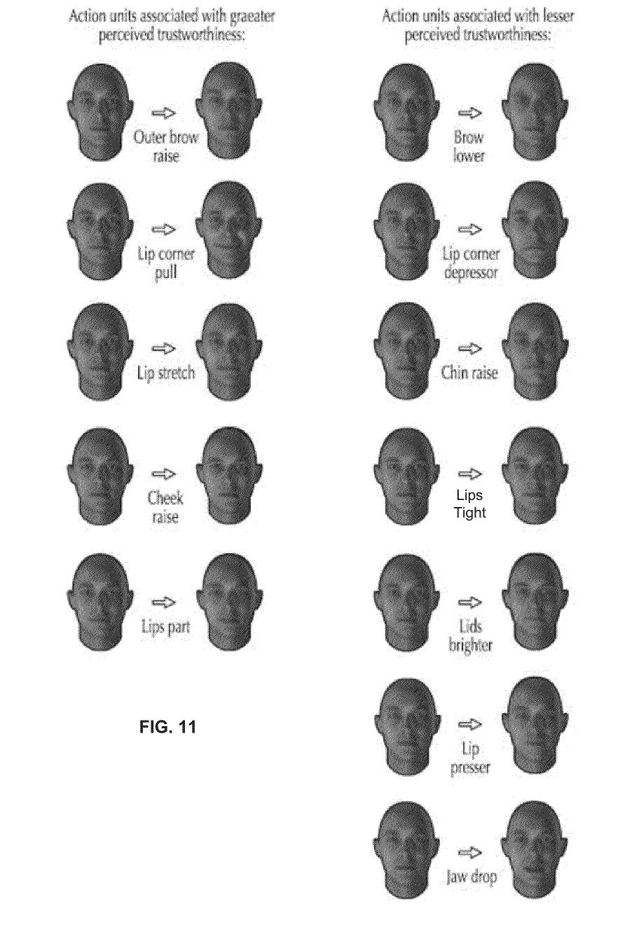

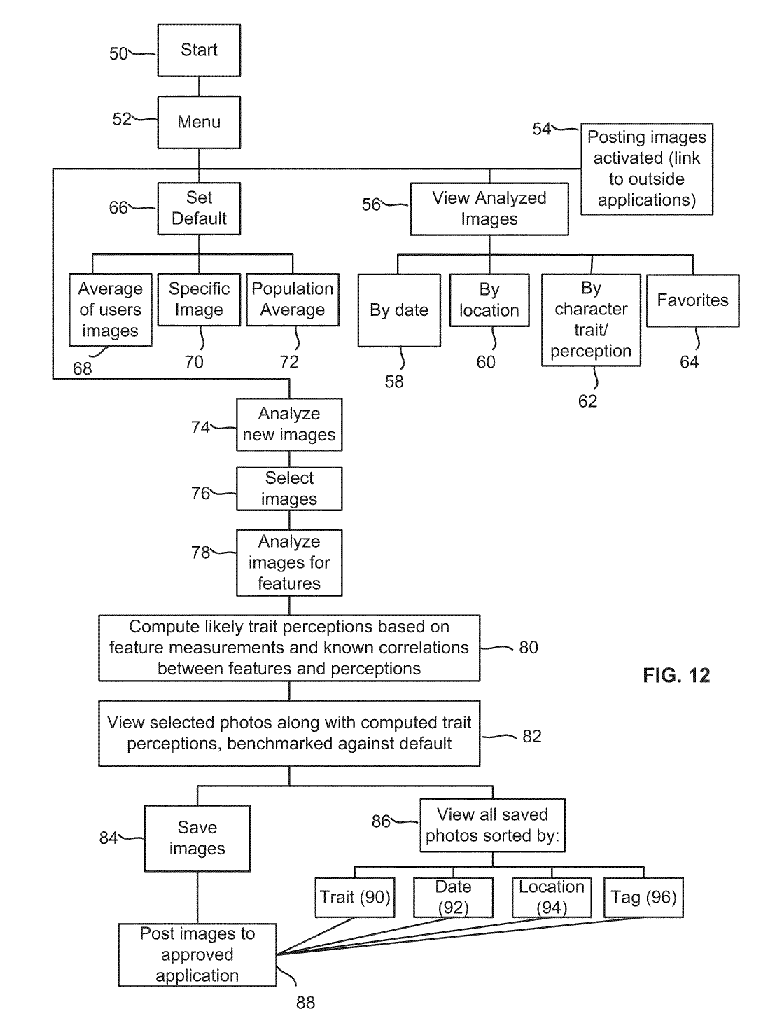

The response device may also allow the viewer 1 (responder) to indicate a response that identifies a degree of a particular perception. For example, a degree of trustworthiness on a scale of 1-10. The response may be based on images as described previously, or the response may be based on any type of content such as video or audio content. The system tracks the responses and identifies features of the content 21 to determine patterns that associate features with perceptions. These associations are stored in a data set on the storage 10. The data set may also include control images that allow for identification of features. For example, the left image of the image pairs in FIG. 11 may be considered a neutral image and the right image may be the control image. The neutral image being one of no expression and the control image being one of a visual feature being displayed. The software may take into account that the identified feature is between the neutral image and the control image in intensity when determining the likelihood of a perception.

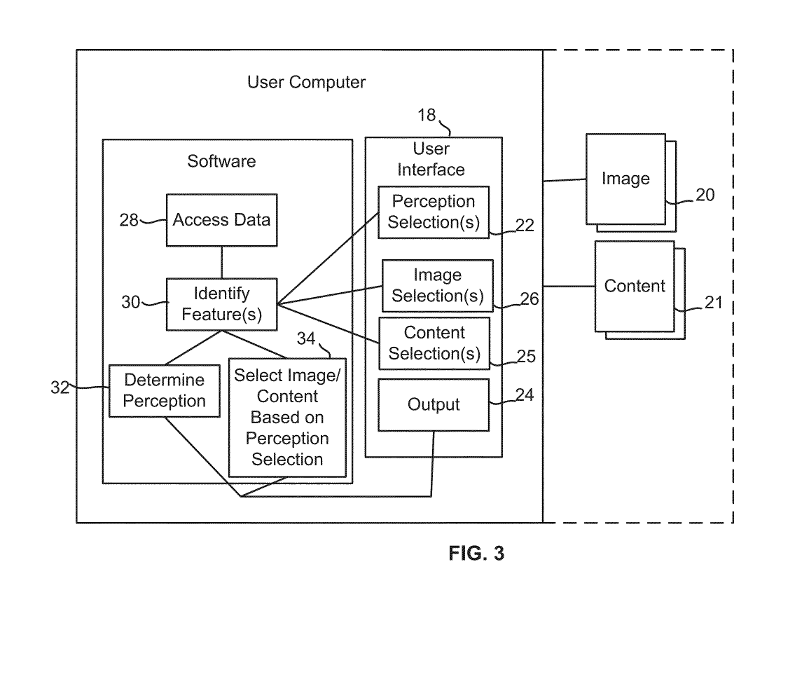

In FIG. 3, the images 20 are uploaded to the user computer. Content 21 other than images may be loaded. Although some figures relate specifically to content that is images, it is understood that other content such as videos and sound recordings can be substituted.

The images may already stored on the user computer (which may be a mobile device). In the User interface 18, a perception selection 22 and image selection 26 is made. Alternately content selection(s) 25 can be made. The perception selection may indicate that the user desires to know which photo(s) or if a particular photo is likely to elicit a certain emotional response or perception. For example, “trustworthy”. The software accesses data 28. The data 28 associates visual features with features in an image. For example, the visual features may be facial features and the features in an image are identified 30 in order to determine the association. The association may be a similarity rating such as a percentage. As one example, referring to FIG. 11, the similarity rating may take into account how close the identified feature is in comparison to a scale measured from neutral (left image) to a control feature (right image) for each of the action units identified in FIG. 11. These action units are just a few examples of many possible facial features that can be recognized. The similarity rating may be 50% if the “outer brow raise” is part way between the left and right images as shown in FIG. 11 as one example.

The combination of features can also be compared to identify the features in relationship to their statistical likelihood that certain perception will result. For example if an individual has an outer brow raise, lip corner depressor, and a chin raise, each of the features may have a % likelihood of trustworthiness (or other perception). Therefore, based on a combination of multiple features identified and a statistical likelihood of a certain perception, a likely perception can be determined 32.

In one embodiment, the system allows for upload of multiple images and selection of a desired perception. The software therefore selects 34 from the images (or content) which one has the highest likelihood of the perception selected 22. The perception for each image may be determined as done with one image's perception is determined 32. The software then outputs 24 the image, file path, image name or other identifier of the image (or content).

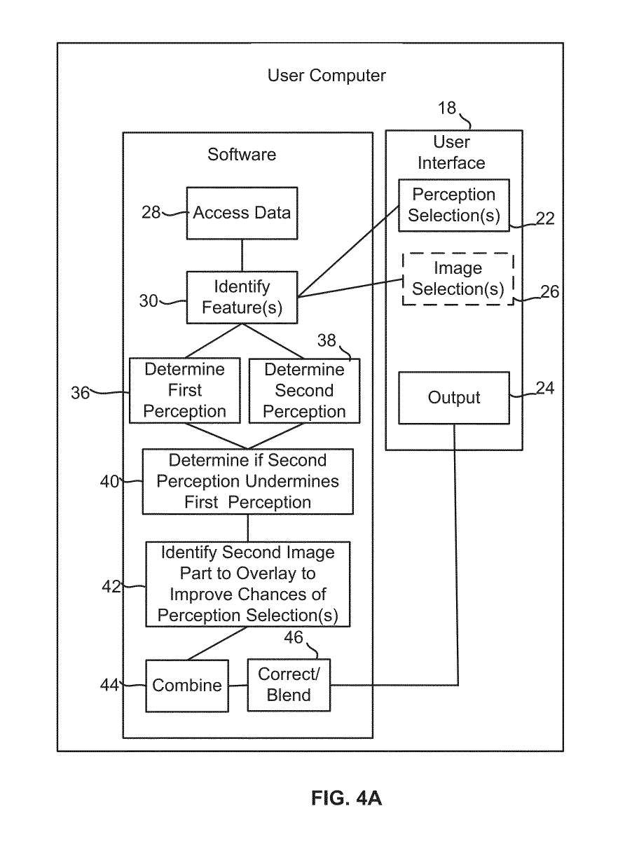

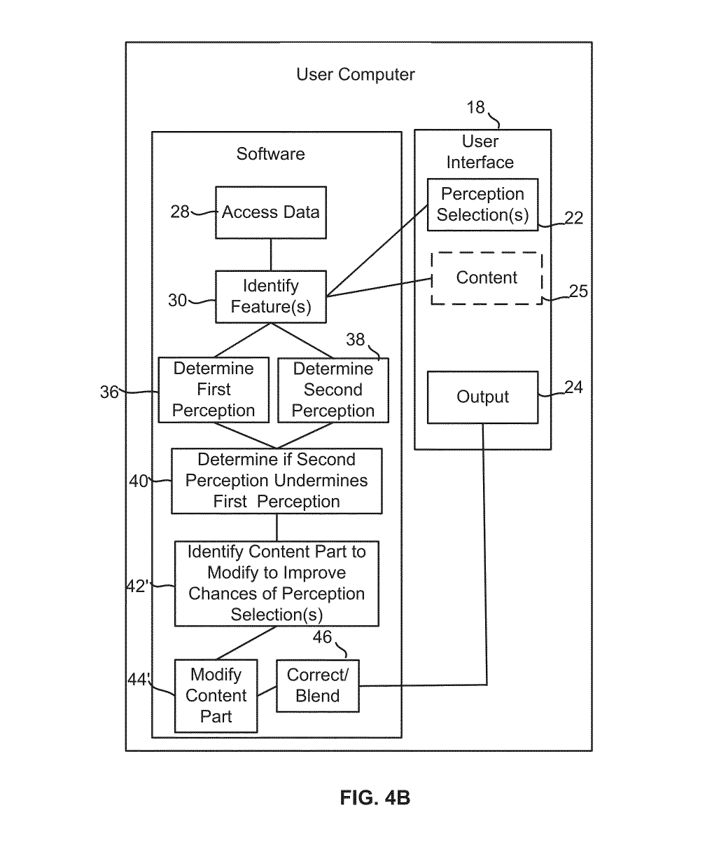

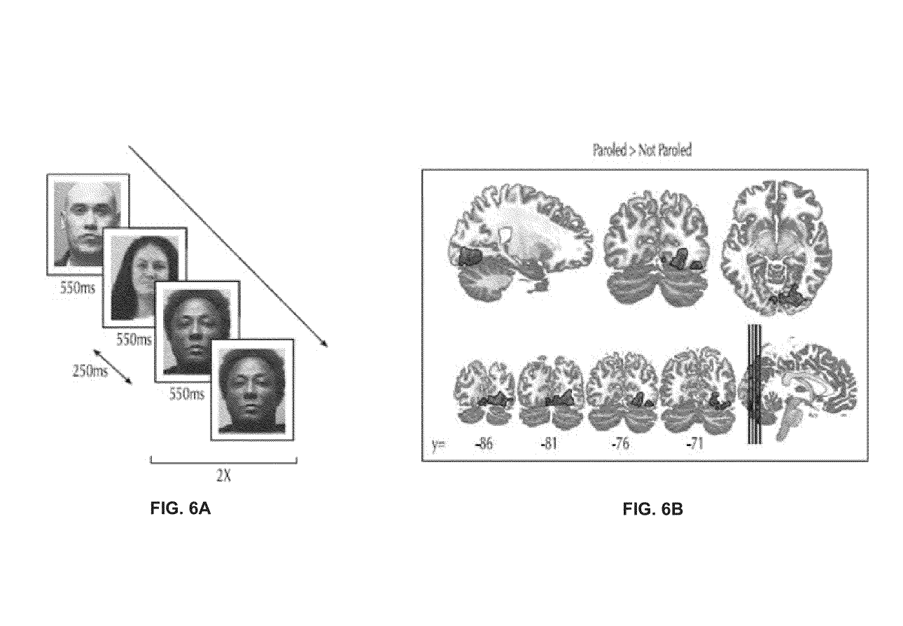

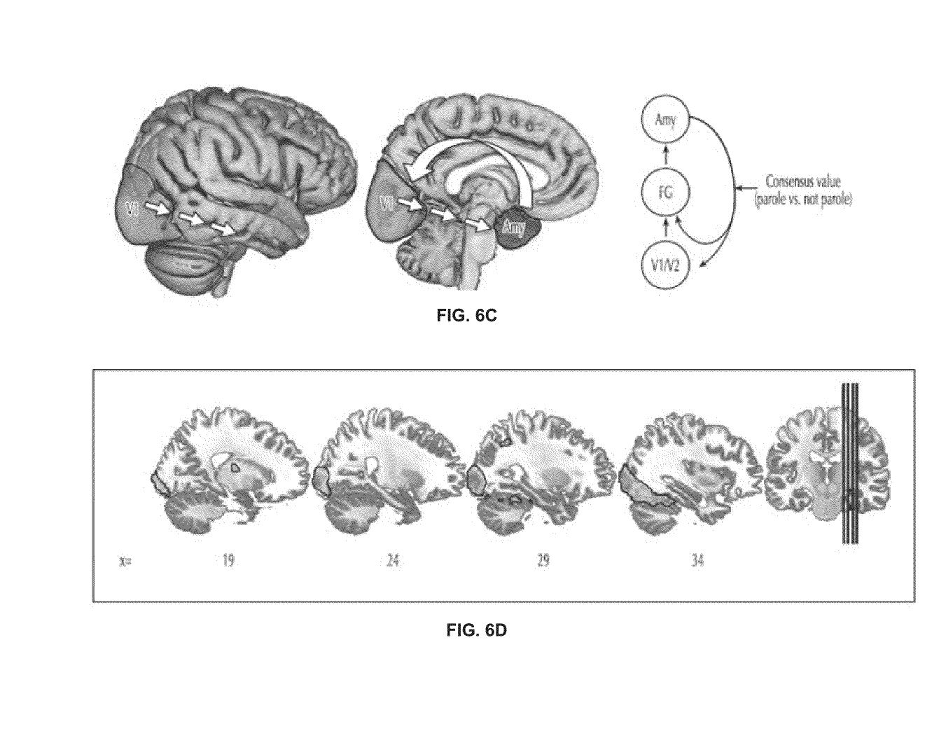

In FIG. 4A an aspect of the system is shown where the computer generates an image by combining desirable features from more than one image. In order to do this, the features are identified 30 and a first 36 and secondary 38 perception are determined. For example, the subject may have an outer brow raise and a lip presser identified 30 in one photograph. (See FIG. 6 for examples). In this case, the outer brow raise would indicate trustworthiness, but the lip presser may indicate lesser trustworthiness. Thus, the lip presser would undermine the perception associated with the outer brow raise and the software is able to determine 40 this. The images available to choose from may include the same subject where the lips part feature is identified 42. In this case, an improved photograph can be generated by combining 44 the lips part with the outer brow raise and overlaying the lip presser feature with the lips part feature. The combined photograph is then corrected/blended 46 for color and shading and output 24. FIG. 4B shows an embodiment similar to FIG. 4A, but more generally as to content, which may be video, audio, image content or combinations thereof. In FIG. 4B, once perceptions are identified based on the identified features 30, the software modifies part of the content 42′ to improves the chances of a desired perception. For example, this may change a color filter setting on an image or video, modify background noise and change the speed of parts of the video while modifying speech patterns to slow without changing pitch. These are but some examples of modifications that can be made and others are contemplated as would be apparent to one of skill in the art.

FIG. 10 shows an example of the process and options provided by user interface 18. The menu 52 allows for setting the defaults 66 for analysis of images. For example, the average of all users images 68 may be used, specific images 70 may be used or population averages 72 may be used. Other defaults may be based on geographic area or other characteristic. These defaults may be considered control images. Once the defaults are set, these defaults associate a perception with visual features, and depending on the default selected, different results are possible. The user can view analyzed images 56 by date 58, location 60, character trait/perception 62 or their favorites 64. The system also provides for posting images 54 which allows linking to outside applications such as social media applications or others. The system also provides for upload and analysis of new images 74. The images are selected 76 and analyzed for features 78. The trait perceptions are determined based on known correlations 80 and the new photograph(s) are displayed and benchmarked against defaults 82 to determine how the new image compares to the default. The images are saves 84 and may be posted to an application 88 such as Facebook® or Linkedin@. The system also allows sorting of photos 86 by trait (perception) 90, date 92, location 94 and tag 96. Other sorting metrics are contemplated.

The software reviews images selected by the user, evaluating the photograph, and then returning the data to the user, in the form of likelihoods that someone looking at each photograph would perceive different personality traits. Referring to FIG. 11, the user would select the photographs from their phone (either the camera function, or the downloads folder) that they wished to have analyzed (Screens 3 & 4). The selected photographs are then fed through computer vision algorithms that are able to detect various facial features (e.g. nose; eyes; mouth.) and measure their size. These measurements are then combined with knowledge about which features are associated with which types of perceptions (See FIG. 6 for examples relating to trustworthiness), to produce a metric of how likely each photograph is to produce each type of perception. This information is then displayed to the user, in various formats.

For example, users can scroll through all the photos in the batch that they just uploaded, and view the ratings for each on each personality scale, relative to a default that they've pre-selected (this default could be the average rating of all the photographs they've uploaded, or the ratings for a specific photograph that they like, or a population average, pre-loaded onto the application). This view is displayed in Screen 5. As they view photographs, users have the option to save their favorites. Once a user has saved selected photographs, they also have the option of viewing only their favorite photographs together, so that they can see them—and their ratings—side by side (Screen 6).

By default the application will provide ratings along each of the different personality traits measured (listed below), but users can also choose to view photographs sorted by their ratings along a specific personality trait (Screen 7). Once users have selected the best photographs according to the traits they desire to convey, they have the opportunity to upload those photographs to various pre-selected applications on their phone (e.g. Facebook; LinkedIn, Twitter). Finally, once a user has saved enough photographs as favorites, he or she would have the option to conduct a meta-analysis over that database, to identify the feature or feature(s) within their pictures that most consistently cause them to be seen in different ways. This application can also be adapted to analyze and upload voice and video files, according to the same procedure, and using the similar research principles and findings.

In order to understand implicit biases—or the tendency to be influenced by information immaterial to the decision at hand, outside the bounds of conscious awareness—various experiments were run. Many practitioners—from business, to law, to politics—still fail to recognize that their decision making may be biased, and in important ways, that may have a significant impact on society.

In part, this belief appears to be due to an assumption that in real-world environments, rich with individuating information, lab-based biases—often measured in paradigms in which participants are given relatively little data about the people they are evaluating—should be easily overcome. It may also be attributable to confidence in commonly used decision-making “safeguards”: These precautions—which capitalize on dual system theories of cognition—take as a given that bias is the work of the fast, automatic, and emotional “System I”, and work to eliminate it by increasing the reliability with which the slower, effortful, and logical “System II” is engaged in the decision-making process. In contrast, previous research aimed at examining bias in real world contexts has focused on unstructured decision-making environments (e.g. political elections)—where individuals control how decisions are framed, what information is sampled, and how it is weighted. This makes it impossible to say whether bias would persist in situations where these precautions are in place, as in many major organizations today. Finally, concerns about the methodology used in implicit bias research, and the replicability of lab results, likely contribute as well to beliefs that biases, while acknowledged academically, may not apply to one's own decisions, by undermining confidence in the experimental research on this topic.

Disclosed herein is evidence that a belief that bias does in fact persist in structured decision-making environments. Using prison inmates' applications for parole as an example, this disclosure demonstrates that even in an environment rich with individuating information, and specifically designed to preclude any possibility of bias, initial impressions based solely on inmates' appearance can be used to predict whether or not they will be released from jail. Using these findings, other predictions on emotional responses can be determined. This disclosure furthermore shows that this finding is both replicable, and robust across multiple experimental paradigms.

This disclosure further examines the neurobiological mechanisms underlying participants' judgments of the prisoners: Contrary to the common conception of System I and System II as distinct processes, this disclosure demonstrates that affective processes underlying the initial evaluation of prisoners based on their appearance (the so-called System I) directly influence activity within regions associated with the computation of the value of decision options (grant vs. deny parole)—a function commonly assumed to be under the sole control of System II. This demonstrates that the two systems may not operate independently, and highlights one important reason why decision-making precautions based on this framework may fail to be as effective as commonly assumed.

The use of parole applications allows for verification of the methodology because these applications are considered utilizes many of the precautions commonly assumed to preclude the possibility of bias: For example, the parole board is composed of a diverse group of experts (who have significant experience in law enforcement and related fields). Their expertise should allow them to zero in on the most important information, and weight it properly, and their number and heterogeneity should reduce the potential for correlated individual errors (biases). These experts are furthermore provided with a significant amount of information about each prisoner—which should increase individuation, reducing the potential for stereotypes to be applied. The parole board also makes its decisions according to a rubric, which specifies exactly how members are to evaluate and weight the information they are given; this should eliminate any bias that might result from evaluating different individuals based on different criteria. Finally, parole board members have significant motivation to make their judgments objectively (5), both because doing otherwise would be contrary to the rule of law, and because the process is designed to be transparent to the public. Given all of these safeguards, we should expect to see little influence of extraneous variables, like appearance.

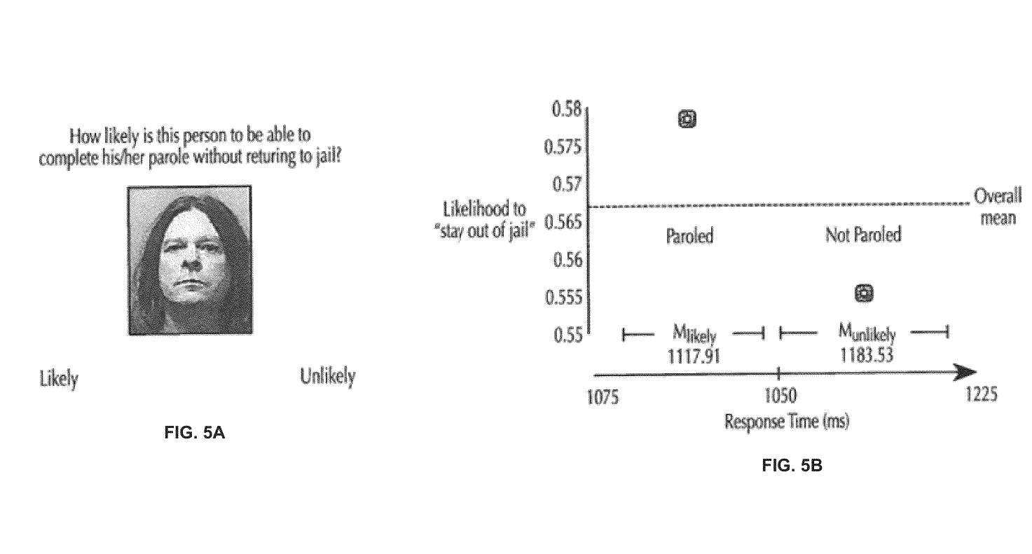

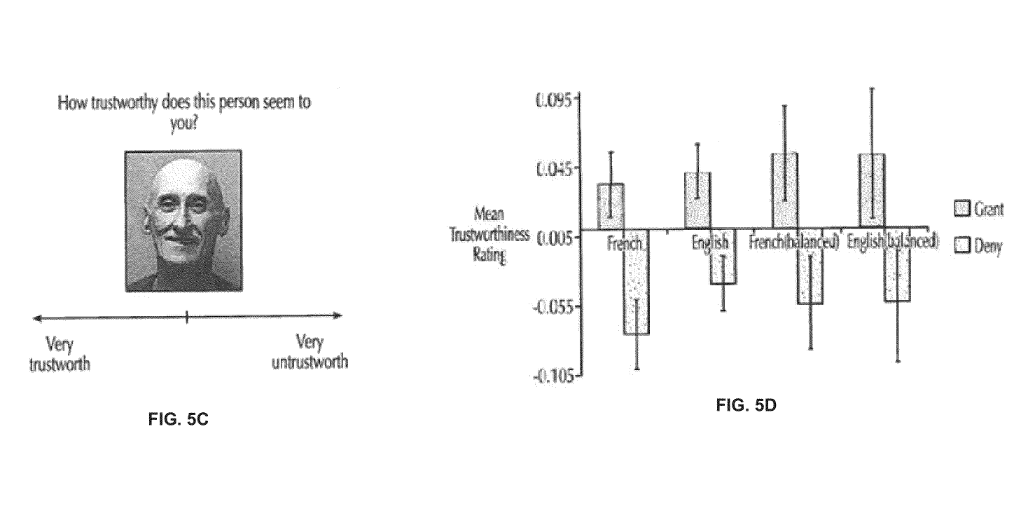

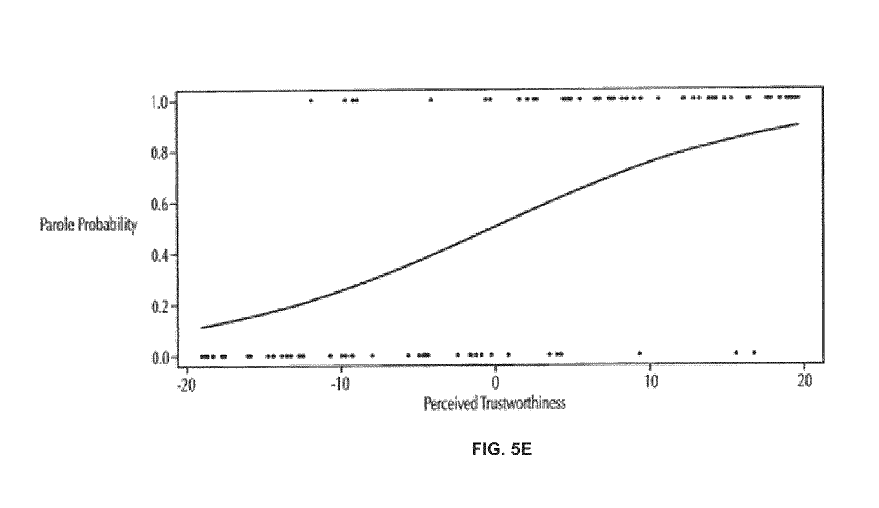

In order to test the hypothesis that decisions specifically designed to be objective may still be influenced by first impressions, we examined every case that came before a large, representative, American prison parole board during a randomly selected three month period (N=1,687). We then set up a simple decision task in which participants (N=49) viewed inmates' prison identification photographs, and were asked to decide whether they thought each individual was “likely” or “unlikely” to be able to stay out of jail, if parole were granted (Experiment 1; FIG. 5A). (So as to ensure that participants were drawing on appearance, and not category-frequency information to infer something about the ‘typical’ law-breaker, we used a pseudo-randomly selected race and gender balanced sample of 128 prisoners.) If the presumption that appearance does not influence parole board decisions were correct, then there should be no significant correlation between the decisions made by the parole board members—who have the prisoners full dossier, and are supposed to make their decisions upon this basis alone—and those recommendations made by strangers, who have access only to prisoners' photographs. Consistent with our hypothesis, however, prisoners who were eventually granted parole by the board were rated, on average, as significantly more likely to be able to successfully stay out of prison by our participants (M=0.58, SD=0.2) than those who were eventually denied parole (M=0.56, SD=0.2), t(48)=2.07, p<0.05 (FIG. 5B).

We next examined the robustness of this effect. Robustness has become increasingly important in light of more general concerns about replicability, and a lack of generalizability across decision-making contexts is one of the primary factors cited in arguments that claim that bias may not apply in real-world decision-making. To test the robustness of our finding to different experimental paradigms, we first examined whether the effect were dependent on participants' knowledge that these individuals were prisoners, and/or the specific judgment they were asked to make about them. We asked a new set of naïve participants (N=74)—who did not know that the people they were looking at were incarcerated—to look at the inmates' photographs, and to rate the degree to which each appeared to be “trustworthy”, or “untrustworthy”, along a continuous (counterbalanced) visual analog scale (Experiment 2; FIG. 5C). Consistent with Experiment 1, participants rated individuals who were eventually paroled as significantly more trustworthy than their non-paroled counterparts, t(73)=4.993, p<0.001 (paired samples t-test; FIG. 5D). We also fit a general estimating equation (GEE) binary logistic regression model to the data (FIG. 5E). Again, we found that participants' trustworthiness ratings were a significant predictor of the likelihood that a prisoner would be granted parole, β=0.113, p<0.001, 95% confidence interval, 0.068-0.158.

We further tested the robustness of this effect by examining whether it was dependent on there being any explicit evaluation at all. Explicit task instructions, for example, may bias attention allocation, creating a differentiation where none would otherwise exist. To determine whether this were the case here, we examined how the distinction between individuals who would later be granted parole, and those whose applications would later be denied, was expressed at the neural level (Experiment 3). Participants completed a standard 1-back task (FIG. 6A), in which they viewed a series of prisoners' photographs, and were instructed to respond by pressing a key when they saw the same photograph twice in a row (approximately 5% of trials), while functional magnetic resonance data was recorded. Participants also completed the same trustworthiness-rating task as described in Experiment 2, outside of the scanner. Analysis of the post-scan behavioral data revealed that, again, participants' perceptions of the inmates apparent trustworthiness predicted the parole board decisions, 3=0.107, p<0.001, 95% confidence interval, 0.061-0.153. Multi-voxel pattern analysis using a searchlight technique was used to try to predict the category of each target person (paroled; not-paroled) that participants were viewing, based on patterns of neural activation. Above-chance correct classification performance was observed in the occipital face area (OFA; M=56.11%), cerebellum (M=69.47%), and nucleus of the solitary tract (NTS, M=57.02%). Together these data demonstrate that judgments based on appearance alone can be used to predict whether or not inmates will be granted early release from prison, suggesting that inmates' appearance may be influencing the parole board's decisions, despite the safeguards put in place. We furthermore show that this effect is both replicable, and robust to variation in the judgment context.

These data do not, however, reveal much about the mechanism(s) underlying this effect. Understanding these mechanisms is, however, important, in particular to understanding why decision-making precautions that are widely assumed to preclude bias appear unable to completely overcome it. In order to examine these mechanisms, we therefore conducted a series of additional studies: First, we replicated a set of results reported within the large extant literature on implicit bias. We then looked at how the prisoners were processed within the brain. Specifically, we examined the processes wherein prisoners are perceived and evaluated, and how these processes interact with the mechanisms underlying explicit decision-making about whether to grant or deny release to specific individuals. Finally, we looked at how the prisoners' appearance may influence affectively neutral information that's presented simultaneously.

These results demonstrate that the phenomenon here shares many of the same characteristics as the implicit biases studied previously, including being made upon the basis of facial features that signal happiness or femininity, being made quickly, and being specific to one of two general social dimensions (here “warmth”), rather than attributable to a general mood or “halo” effect. This suggests that beliefs that implicit bias as measured in the most commonly used experimental paradigms may not generalize may be unfounded. Behavioral data based on self-report, however, is inherently limited in what it can tell us about the processes underlying this phenomenon, in particular because much of the activity underlying implicit biases takes place outside of the bounds of conscious awareness. In order to further elucidate the mechanisms underlying the influence of prisoners' appearance on judgments of their suitability for parole, we therefore examined patterns of activation within and between brain regions known to be involved in social cognition, both when participants were passively viewing the prisoner stimuli, and when they were told that the target persons were inmates, and asked to judge each likely or unlikely to be able to successfully complete his or her parole (similar to the decision put to the parole board).

First we conducted additional analyses on the data from Experiment 3, in which participants viewed the prisoners' photographs, but were not asked to make any explicit evaluations. Whole brain random effects group analyses (corrected for multiple comparisons) revealed multiple regions in which there were significant differences in activation between the two groups (granted vs. denied parole)—with paroled prisoners associated with greater activity in visual cortex and fusiform gyrus (fusiform face area) (FIG. 5B). An additional region of interest (ROI) analysis further revealed significant differences in bilateral amygdala, with paroled prisoners associated with significantly greater activation that non-paroled prisoners, t(28)=2.140, p<0.05 (FIG. 5C). Finally, a psychophysiological interaction between the prisoner groups and functional connectivity between the amygdala and visual cortex was identified, with greater functional co-activity for paroled vs. non-paroled prisoners (FIG. 5D), suggesting selective perceptual enhancement of the images of prisoners in this group, mediated by the difference in amygdala response. These results are in line with the large literature demonstrating the involvement of these regions in social cognition, and further the current understanding of their function by demonstrating the ability of positively valenced social information (i.e. trustworthiness) to be weighted more heavily by the amygdala than its negative counterpart (even when attending to the positive stimuli is not part of the task; c.f.), and to drive emotional attention effects similar to that typically provoked by fear-related information. This is notable in particular in light of recent behavioral findings that demonstrate that bias may be realized in a more flexible manner than previously recognized, with perceivers differentiating between desired and undesired others either by focusing on the negative aspects of the out-group, or by selectively accentuating the positive characteristics of the in-group.

Whereas this tells us about the mechanism for making normative judgments, there is also a lot of variance in these judgments; in Experiment 4, for example, approximately one third of the variance in participants' judgments about the prisoners' character traits was attributable to differences between the subjects, rather than differences between the stimuli. What happens when normative judgments and individual-level idiosyncracies interact? In order to examine this issue, we conducted a second neuroimaging study (Experiment 5). We utilized an event-related design, in which participants were instructed that they would be viewing images of prison inmates who would soon become eligible for parole, and told to indicate, for each prisoner, whether they thought he or she was likely or unlikely to be able to complete his or her parole successfully (i.e. not return to jail) if granted early release. We then analyzed BOLD activation as a function of both the prisoners' parole status (granted vs. denied—used here to index normative judgments as well), and the individual participant's classification of the prisoner as likely or unlikely to be able to stay out of jail, if released.

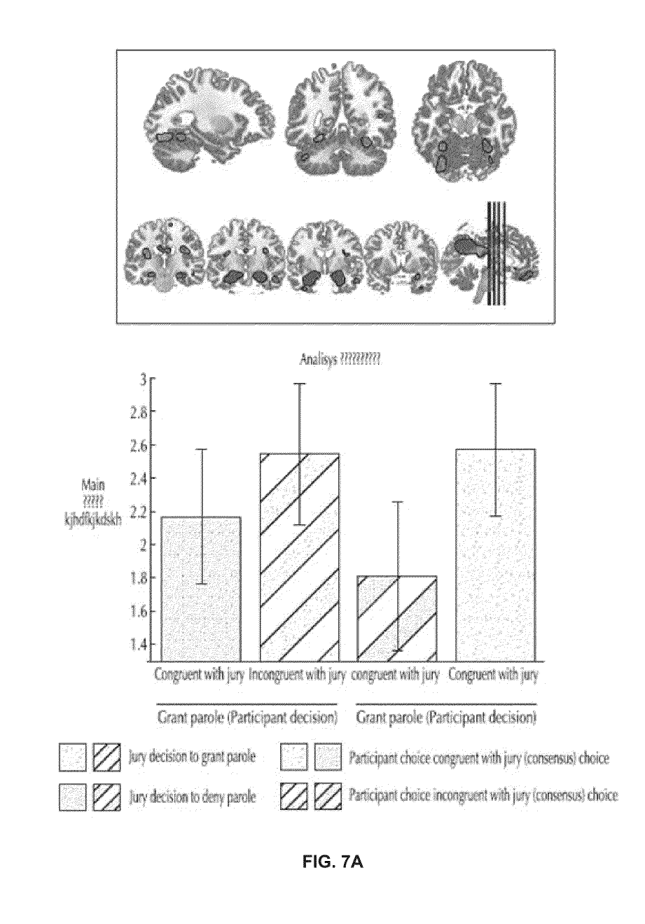

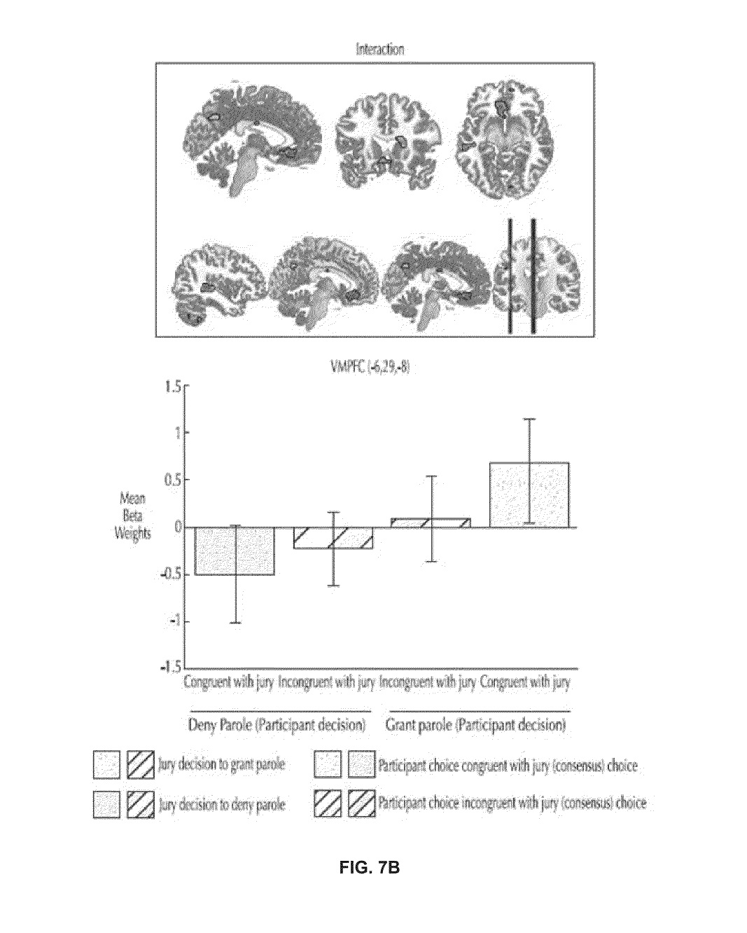

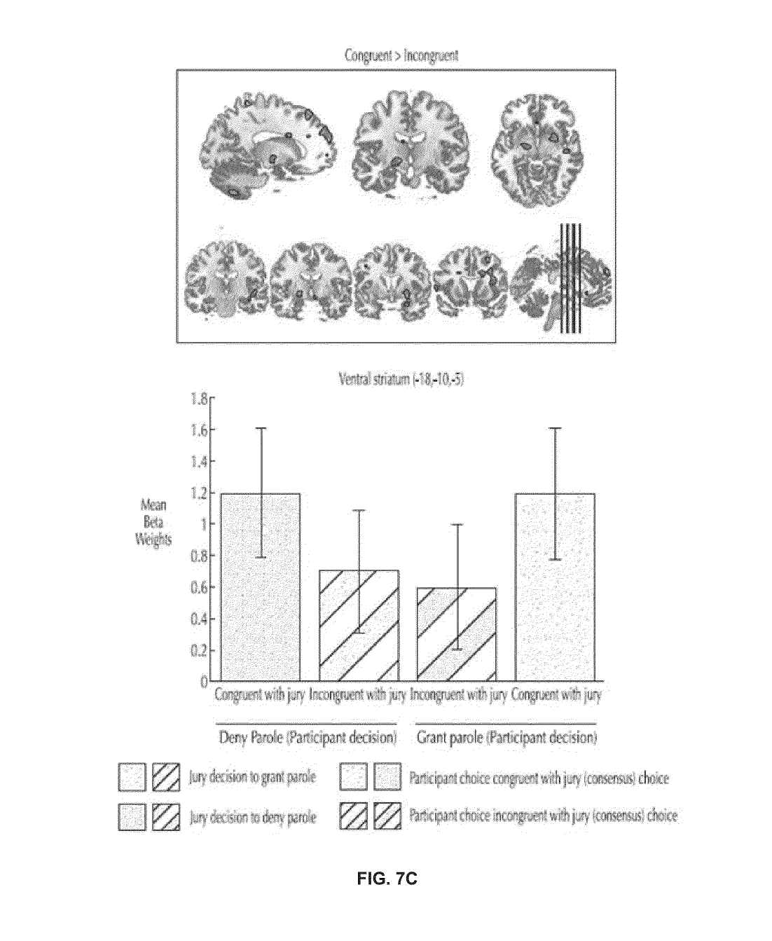

Analysis of post-scan ratings replicated the primary finding that perceptions of prisoners' trustworthiness predicted their eventual parole status, β=0.130, p<0.001; this further demonstrates that the result is robust to raters' prior knowledge about the participants, and to variation in the decision-making paradigm. Analysis of the neuroimaging data further revealed that activation in the amygdala and visual cortex (FIG. 7A) differentiated prisoners who would and would not receive parole, with greater activation for the former, replicating the finding from Experiment 3. That perceivers are still differentiating between the two groups of prisoners via enhanced perceptual processing for the positively valenced (trustworthy) target persons even in this explicit judgment paradigm is even more notable in the context of previous research suggesting that any bias the brain has towards weighting negative information more heavily may become more pronounced when stimuli are explicitly attended to.

We then tested whether the brain is tracking idiosyncratic decisions, and how these decisions and normative categorization of prisoners as trustworthy versus untrustworthy (mediated by the amygdala) interact. Results reveal a distributed functional network supporting a complex decision making task: Decisions grant (versus deny) parole were correlated with increases in activity in ventromedial prefrontal cortex (vmPFC) and the medial temporal gyrus (MTG), locations previously associated with the calculation of subjective value (an integral step in decision-making), and social identification and empathy; conversely, decisions to deny (versus grant) parole were not associated with increases in activation. We also found a significant interaction between the normative categorization and individual decision-making processes in vmPFC, such that the greater activation associated with prisoners the individual chooses to release versus keep in prison is modulated by the normative (population average) categorization of that target person as trustworthy or untrustworthy (FIG. 7B). This region—which has previously been implicated in emotional and monetary valuation processes—thus here appears to be involved in integrating distributed knowledge—in particular that of the normative classification, and the individual's idiosyncratic classification—calculating the potential value of the trust decision. This is important, because it suggests that emotion may influence valuation, which is a core tenant of system II processing, suggesting one reason why the safeguards described earlier may still “miss” some of the bias. This suggests a modulatory role for emotion in social valuation and decision-making (similar to what has been previously been found for memory, attention, and perception), rather than that described by the dual systems approach.

We also identified a second interaction effect, when participants make decisions that are congruent vs. incongruent with the normative categorization of the prisoners as trustworthy or untrustworthy—in other words, when one elects to release a prisoner who looks trustworthy, or chooses to deny parole to one who looks untrustworthy. Here the results revealed widespread activation distributed across multiple cortical and subcortical regions, including the dorsolateral and dorsomedial prefrontal cortices, ventrolateral prefrontal cortex, striatum, precuneus and medial temporal lobe (FIG. 7C). These regions—in particular the ventral striatum—have previously been implicated in linking the affective nature of a stimulus with the value of an action in response that cue. In the context of the decision task used here, this network may thus be involved in evaluating the appropriateness of the two decision option—grant or deny parole—in light of the subjective value of the stimulus (as calculated in the vmPFC). The ventral striatum is also, notably, a key part of mesolimbic dopamine system, and has been linked, via this role, to habit formation in decision-making. Its potential involvement in the selection of actions that are congruent with the fast, uncontrollable, amygdala-mediated categorization of prisoners as trustworthy or untrustworthy based on their appearance may thus suggest one reason why bias appears to be so difficult to overcome.

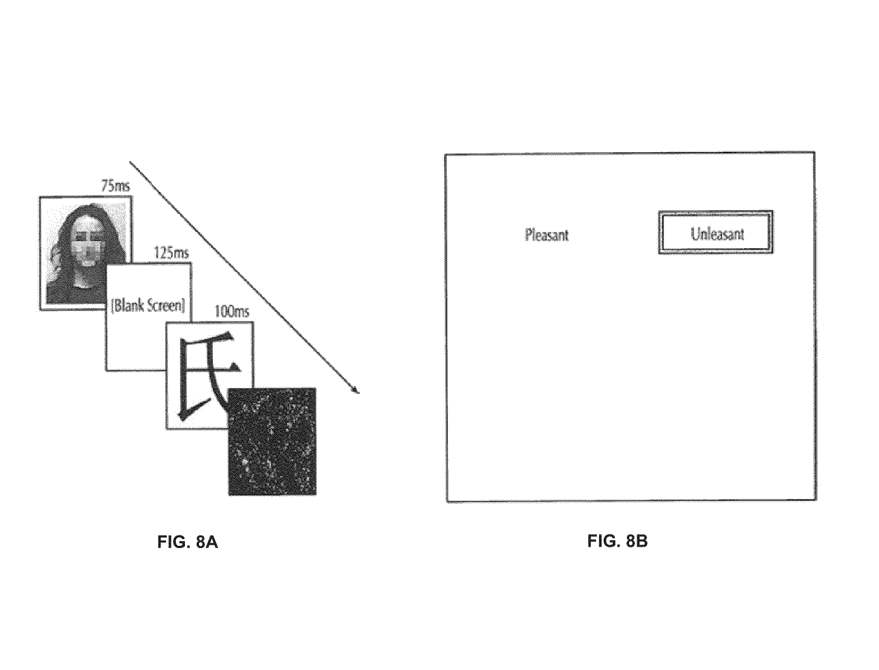

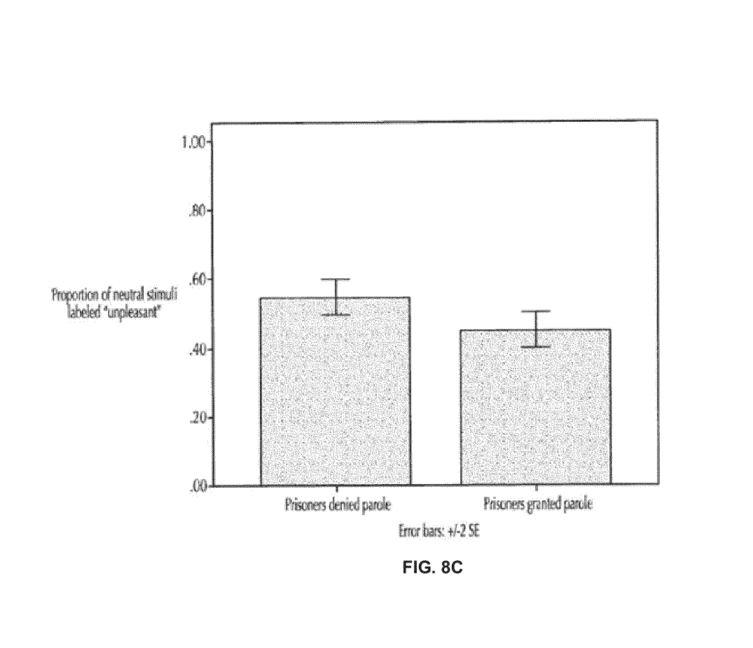

Together these data thus demonstrate a lot about the mechanisms by which the prisoners are perceived, and viewers are evaluating their appearance. In the real world, however, after seeing someone for the first time, we are also exposed to additional information about that person—the information on which we're in theory supposed to be making our decisions (and which people have argued should overwhelm any biases based on appearance). Previous research has suggested that people may simply neglect (fail to attend to) more diagnostic information, when more easily processed cues (such as appearance) are available. Given our results, which demonstrate that prisoners' appearance is processed via affective pathways in the brain, and given previous research demonstrating that affective information may be easily misattributed to the wrong source (in part due to the lack of conscious access to the pathways by which this information is initially processed), we suggest an alternative hypothesis: Specifically, we posit that people may misattribute their responses to prisoners' faces to a subsequently presented neutral stimulus (Experiment 6). In order to test this hypothesis, we conducted a final study, using an affect misattribution procedure. In this procedure (FIG. 8A), participants are told that they will be shown a series of unfamiliar characters, and that their task is to indicate how pleasant or unpleasant they believe the characters to be. Before each character, they are shown a prime—here a picture of a prisoner—which is backward-masked, to reduce conscious perception. Finally, after the character is presented, they are shown a blank screen, on which they are to indicate whether the character presented to them was pleasant or unpleasant. Whereas the characters themselves are affectively neutral, the prisoner faces are not, so to the extent that the affective valuations of the faces may carry over to the neutral stimuli, these should be evaluated in a positive or negative way as well.

As hypothesized, we found that people used the term “unpleasant” more often to describe neutral stimuli proceeded by prisoners who were eventually denied paroled than for neutral stimuli proceeded by prisoners who were eventually released, t(29)=1.920, p<0.05 (FIG. 8A-C). This suggests that the affective information conveyed by prisoners' faces can be misattributed to subsequently presented neutral cues, and raises the possibility that objective, diagnostic, information, instead of being neglected in cases of bias, may be instead misconstrued, in a direction congruent with the perceiver's initial categorization of the target person on the basis of his or her appearance. This is important because it suggests different types of interventions for combating bias. Whereas the view that information may simply be more likely to be neglected when subjective cues like appearance are available would suggest interventions designed to ensure that each data point is seen by each decision-maker—similar to strategies based on dual system theories of cognition, and to the precautions in practice today—bias mediated by affective misattribution would not be susceptible to these measures, and would suggest the need for a different approach.

Therefore, biases based on appearance persist, despite multiple safeguards, including the presentation of a large amount of individuating information, the use of expert decision-making, a group decision making context, and a data driven rubric, which both explicitly defines the variables that one are included in the decision making process, and lays out exactly how they should be weighted (relative to each other). We furthermore demonstrate that this finding is robust to variations in the decision-making process, and extend this using both neuroimaging and behavioral data to demonstrate that participants are making their differentiations by picking out the positive appearing versus negative appearing prisoners, in line with basic neuroscience work showing that the amygdala can respond to both positive and negative, but which has not previously been shown in social judgments, which have long been assumed to be primarily attuned to threat. Finally we show that normative categorizations and individual decisions interact, in ways that potentially incentivize making decisions in line with the consensus, and that the affective information from the face can influence subsequently presented information. Together, these data demonstrate within the context of a social decision-making paradigm that the common assumption that there are separate affective and deliberative processes may not be as clear-cut as previously assumed, and that this has important policy implications. these implicit bias processes may be attenuated (or enhanced) depending on the perceivers belief that the characteristic that they are inferring from appearance actually matters to the decision making process.

Stimuli.

The same stimulus set was used in each study described here below. We first obtained the list of all inmates in the Nevada State Prison System who would become eligible for parole over a period of three months (Aug. 1, 2012-Sep. 31, 2012)—2,142 individuals in total. Photographs, demographic information, text descriptions of physical characteristics, parole outcome data were obtained through the Nevada Department of Corrections. Of the 2,142 inmates eligible for parole during the period sampled here, photographs were available for 1,687 (78.76%). All photographs were shot in a standardized headshot style, including the head and neck/shoulder area, against a plain background (see example in FIG. 5A). Where the original photo background was not solid, Adobe Photoshop was used to remove any items that appeared behind or beside the inmate. Analysis of these images revealed no significant luminosity or contrast differences between photographs of prisoners granted versus denied parole.

In addition to information identifying inmates eligible for parole, we also obtained from the Nevada State Parole Board information about the action taken by the Board. For the purpose of this analysis, we considered only those inmates whose cases were taken up for consideration during the three month period analyzed here. Inmates who become eligible for parole but who elected not to have their cases considered were not included in this analysis, as no decisions were made in those cases. Action information for each case was recorded and used as the outcome variable of interest (see “Data Analytic Strategy” below).

Response Measures.

Three different types of response measures were used in the studies reported here. In the explicit prisoner rating tasks (the first behavioral experiment, and second neuroimaging experiment reported here), responses options were displayed as depicted in FIG. 5A, with participants recording their judgment by pressing one of two specified buttons on the provided keyboard or response handset, respectively. The location of each response option (on the right or left of the screen) was counterbalanced across participants. Pleasantness judgments (last experiment) were made on a similar dichotomous scale, though this time with the response options “pleasant” and “unpleasant” (directionally again counterbalanced). Trustworthiness ratings were made on a VAS anchored at either end by the labels “very trustworthy” and “very untrustworthy”. VAS scale directionality was counterbalanced across subjects in all experiments.

Participants.

Participants for Experiments 1 (N=49), 2 (N=74), 3 (N=30), 4 (N=49), 5 (N=−106), 6 (N=183), 7 (N=30) and 8 (N=51).

Procedure.

For each of the experiments described below, participants were first informed of the nature of the study and of what would be required of them, and provided written informed consent. In each case participants also provided basic demographic information, including gender and age, before the experiment began. All behavioral experiments were completed on a desktop computer, with a 22 cm display monitor placed at eye level, approximately 60 cm from the face. A USB mouse and keyboard were used to record participants' responses. Functional neuroimaging data for Experiments 3 and 7 were acquired at a brain and behavioral laboratory using a 3T Siemens Trio scanner with a 12-channel head coil, however it is contemplated that the data can be obtained with other scanners.

Experiment 1.

After providing informed consent, participants were instructed that they would see a series of images, and that their task would be to rate each of the individuals they would see according to how trustworthy or untrustworthy he or she appeared. Participants were informed that there were no right or wrong answers, and that we were only interested in their first impressions. Participants viewed each photograph individually, and made their selections from two options (“likely;” “unlikely”) presented underneath (FIG. 5A; 128 trials per participant). Participants were instructed to respond as quickly and as accurately as possible, but no time limit was given. All participants certified to the experimenter that they understood the directions and completed a short practice session (3 trials) prior to beginning the experiment. They then completed 150 experimental trials—with stimuli selected in random order—in 6 blocks. Participants were allowed to rest in between blocks, so as to minimize fatigue. After completing the last block of trials, participants were fully debriefed and thanked for their participation.

Experiment 2.

In Experiment 2, participants were informed that they would be shown a series of photographs, and that their task was to indicate, using the scale provided, how trustworthy or untrustworthy the target person appeared to them. Participants were informed that there were no right or wrong answers on this task, and that we were simply interested in their first impressions. Participants were asked to record their responses as quickly as possible. All participants completed a short practice session prior to beginning the experiment. They then completed 150 experimental trials—with stimuli selected in random order—in 6 blocks. Participants were allowed to rest in between blocks, so as to minimize fatigue. After completing the last block of trials, participants were fully debriefed and thanked for their participation.

Experiment 3.

Participants in Experiment 3 completed both functional neuroimaging and behavioral measures: During the first half of the experimental session, participants completed a basic 1-back task (S1), the goal of which was to respond as quickly as possible (by pressing a button) whenever they saw the same image twice in a row (which occurred in approximately 5% of all trials). Participants completed six “runs” of this task, each of which lasted approximately 5 minutes. Each run consisted of ten 16 s blocks of stimulus presentation, interleaved with ten 16 s blocks of fixation (FIG. 9A). During each stimulus presentation block, 20 photographs were presented foveally at a rate of 1/800 ms (550 ms presentation time; 250 ms inter-stimulus-interval). With each block, photographs were all either of paroled or of non-paroled individuals, and the order in which blocks (paroled; non-paroled) was determined randomly for each of the six runs. The order in which participants completed each of the six runs was determined randomly, per participant.

While fMRI data were collected, participants also completed a short “face localizer” task, designed to identify regions of the face-processing network. This task followed a similar format to the first part, with participants instructed to press a response button as quickly as possible when they saw the same image twice in a row, and with same stimulus latencies and presentation parameters. Here, however, instead of prisoners, images depicted either faces, objects (houses), or scrambled images (FIG. 9B). Finally, at the end of the experimental session, participants also completed a trustworthiness-rating task (using the same experimental set-up as in Experiment 2) outside of the scanner. This was done to ensure that the phenomenon measured inside the scanner was behaviorally similar to that identified in the previous experiments.

In the figures herein the areas of the brain images with identified activity are outlined in black. See FIGS. 6B, 6C, 7A-C.

Image acquisition parameters were as follows: All fMRI data were acquired at the Brain and Behavioral Laboratory at the University of Geneva using a 3T Siemens Trio scanner with a 12-channel head coil. 180 contiguous BOLD contrast volumes (TR=2000 ms; TE=30 ms; flip angle=80°, matrix=64×64, FoV=192 mm, 35 slices, slice thickness=3 mm), and 1 high-resolution whole-brain T1-weighted image (TR=1900 ms; TE=2.27 ms; FoV=256 mm; matrix=256×256; flip angle=90°; slice thickness=1 mm; 192 slices; TI=900 ms) were collected for each participant. Pupillary dilation was measured using an Applied Science Laboratories EYE-TRAC® 6 Series model eye-tracker. Pupil size was recorded at a frequency of 60 Hz, and temporally synchronized with stimulus presentation.

Experiment 4.

The procedure for Experiment 4 was the same as for Experiment 2, but using a pseudo-randomly chosen subset of the stimuli (N=128), balanced for race (Caucasian; African-American) and gender (Male; Female). Stimuli were shown in random order, with each participant seeing each stimulus once (128 trials per participant in total.) Trials were split into 4 blocks, so as to minimize participant fatigue. After completing the last block of trials, participants were fully debriefed and thanked for their participation.

Experiment 5.

The procedure for Experiment 5 was the same as used during Experiments 2 and 4. Naïve participants were instructed that they would see a series of photographs of people, and that they were to rate each person along the specified dimension. In this case though, instead of trustworthiness, half the participants were assigned to rate the photographs according to how dominant the target person appeared (with the continuous VAS anchored on either end by the labels “very dominant” and “not very dominant”), and the other half were assigned to rate the photographs according to apparent competence (“very competent”; “not very competent”). The race and gender balanced set of photographs developed in Experiment 4 was used again here, and stimuli were again shown in random order, with each participant seeing each stimulus once (128 trials per participant in total.) Trials were split into 4 blocks, so as to minimize participant fatigue. After completing the last block of trials, participants were fully debriefed and thanked for their participation.

Experiment 6.

In Experiment 6, participants completed a trustworthiness rating protocol, as described in Experiments 2, 4 and 5. In Experiment 6, participants completed the protocol on a personal computer.

Experiment 7.

In Experiment 7, participants completed an explicit evaluation task while functional neuroimaging data were recorded. The experimental protocol and participant instructions for Experiment 7 were the same as those described for Experiment 1. Here instead of completing the task on a desktop computer, participants viewed the prisoner photographs, and make their selections (likely vs. unlikely to be able to complete one's parole without reoffending) in an fMRI scanner, and indicated their response selections using a handheld response device, on which there were two buttons—one for each option. Participants judged a race and gender-balanced set of 150 pseudo-randomly selected prisoner photographs, split into two experimental blocks of 75. Each photograph was presented foveally for 550 ms each, with a randomly determined inter-stimulus interval between 2000 and 5000 ms (average: 3500). Participants were instructed to make their decisions as quickly and as accurately as possible. Once a selection was made, a box appeared around the chosen response option in order to indicate to the participant that his or her response was recorded, but the trial did not advance until the full 550 ms had elapsed. Participants also completed a trustworthiness-rating task (using the same experimental set-up as in Experiment 2) outside of the scanner. This was done to ensure that the phenomenon measured inside the scanner was behaviorally similar to that identified in the previous experiments.

Image acquisition parameters were as follows: All fMRI data were acquired at the Brain and Behavioral Laboratory at the University of Geneva using a 3T Siemens Trio scanner with a 12-channel head coil. For each of the two experimental blocks, 180 contiguous BOLD contrast volumes (TR=2100 ms; TE=30 ms; flip angle=80°, matrix=64×64, FoV=192 mm, 35 slices, slice thickness=3 mm), and 1 high-resolution whole-brain T1-weighted image (TR=1900 ms; TE=2.27 ms; FoV=256 mm; matrix=256×256; flip angle=90°; slice thickness=1 mm; 192 slices; TI=900 ms) were collected for each participant. Pupillary dilation was measured using an Applied Science Laboratories EYE-TRAC® 6 Series model eye-tracker. Pupil size was recorded at a frequency of 60 Hz, and temporally synchronized with stimulus presentation.

Experiment 8.

In Experiment 8, participants were instructed that they would see a series of Chinese characters, and that their task was to classify the appearance each character as either “pleasant”, or “unpleasant”, in their opinion. Target characters were then presented one at a time, according to the following procedure (see FIG. 6B): First, a prime would be presented in the center of the screen for 75 ms. The prime was a prisoner photograph, randomly selected from the race and gender balanced set (N=128) described in Experiments 2 and 3. Next, a blank screen was presented for 125 ms, followed by the target character for 100 ms. After the target character disappeared, a visual mask was displayed until the participant made his or her selection. Once the selection was made, the next trial would begin. Each participant completed 128 trials in total, with stimuli presented in randomized order.

Data Analytic Strategy.

The goal of each of the studies presented here was to test whether parole board actions could be predicted, in part, based on the degree to which individual inmates appeared to be trustworthy, as rated by study participants. In order to test this hypothesis, the six potential parole board actions (the outcome variable of interest) were first binned, into one of two categories: Decisions that would allow a prisoner to be released on parole (i.e. decisions to grant or to reinstate parole) were categorized as “positive”. Decisions that would result in the prisoner remaining in or returning to jail (i.e. decisions to deny, rescind, or revoke parole) were categorized as “negative”. These categorizations comprised the conditions referred to each experiment.

Experiment 1.

In Experiment 1, we recorded dichotomous choice data reflecting whether participants' beliefs about inmates' ability to successfully complete their parole if granted. Participants' choices were then examined for group mean differences between inmates ultimately granted vs. denied parole. To do this, data from Experiment 1 (dichotomous choice task) were first recoded (0=trials for which the participant responded that the participant was “unlikely to be able to successfully complete his or her parole without reoffending if released from prison; 1=trials on which participant responded that the prisoner was “likely to be able to complete his or her parole without reoffending if released from prison”). Response values were then averaged across trials within each condition (prisoners whose applications the parole board granted; prisoners whose application the parole board denied), for each participant. This yielded two indices per person—one proportion (1) representing the fraction of trials on which the participant suggested granting parole to a person who the official parole board also granted early release, and another (2) representing the fraction of trials on which the participant suggested granting parole to a person who the official parole eventually denied early release. These values were then compared using a paired-samples t-test.

Experiment 2.

The goal of the current study was to test whether parole board actions could be predicted, in part, based on the degree to which individual inmates appeared to be trustworthy, as rated by study participants. Trustworthiness judgments were examined for group mean differences between inmates ultimately granted vs. denied parole. In each case, judgments were first z-scored, and then submitted to a paired t-test. Where significant differences in mean trustworthiness ratings were found, a binary logistic generalized estimating equation (GEE) regression model was fit to the data in order to examine the magnitude of the relationship between trustworthiness judgments and parole board decisions, while properly accounting for within-subject covariance (S1-S2). To guarantee a correct specification of the within-subjects covariance matrix, we applied the modeling procedure recommended by (S3): Different structures for the within-subjects covariance matrix were fit to the saturated model containing both main and interaction effects, and compared for goodness of fit using the quasi-likelihood information criterion described by (S4). The final model describes the relationship between first impressions and parole board decisions, all other variables notwithstanding (i.e. the degree to which one could predict parole board decisions if one knew nothing about the severity of the crime committed, nor about any of the risk assessment items). Group means, regression parameters, and significance values are displayed in Table S1.

Experiment 3.

First, trustworthiness ratings made outside the scanner after the imager data were collected were analyzed according to the same procedure described in Experiment 2 to identify whether the same phenomena that we measured in previous studies behaviorally—this differentiation between paroled and not-paroled prisoners—were seen as well within this participant sample, who completed the implicit differentiation task first. In this case, trustworthiness was again found to be a significant predictor of parole decisions, β=0.107, p<0.001.

We then examined the functional neuroimaging data from the implicit evaluation and face localizer tasks. Data were preprocessed and analyzed using SPM8 (Wellcome Trust Center for Neuroimaging, http:/www.fil.ion.ucl.ac.uk/spm/). The SPM8 Manual is attached hereto in an IDS and its content incorporated herein by reference. All images were realigned, corrected for slice timing, normalized to an EPI template (resampled voxel size of 3 mm), spatially smoothed (8-mm full-width/half-maximum Gaussian kernel), and high-pass-filtered (cutoff=120 s). A generalized linear model-based analysis was then used in order to test for sensitivity of the BOLD signal to participants' parole status. As noted above, participants viewed the inmate stimuli in blocks of either paroled or not paroled faces. BOLD signal predictions were modeled by convolving the timecourses of these stimulus blocks with a standard synthetic hemodynamic response function (HRF). Estimated motion parameters were included as covariates of no interest, in order to remove artifacts due to participants' movement within the scanner during the task. This model was then fit to the data and used to generate parameter estimates of activity at each voxel, for each condition and each participant. Statistical parametric maps were generated from linear contrasts between the HRF parameter estimates for the different conditions of interest. Finally, random effects group analyses were performed on the individual-level contrast images, using one-sample t tests.

For the amygdala region of interest (ROI) analysis, we first created subject-specific amygdala masks using the data from the second “face localizer” part of the experiment. In this task, which also followed a basic block design, there were three conditions: faces, objects, and geometric patterns. Data were analyzed using an analogous procedure to that described above for the prisoner task. “Face sensitive” regions were defined as those that were significant in the (faces>others) contrast. To define the ROI, we centered a sphere with a 20-mm radius on the peak coordinates extracted within dusters in the area of the amygdala. This procedure resulted in ROIs of equal size (and thus equal numbers of voxels fed into the classifier) for each participant. Multi-level GLM analyses were then conducted within the ROI.

A psychophysiological interaction (PPI) analysis was then used to examine the relationship between the amygdala and the regions identified in the whole-brain analysis, and specifically how this relationship may be modulated by experimental condition. The PPI analysis followed a similar procedure as described for the prisoner and face-localizer analysis, this time with three regressors: 1) a task regressor 2) a physiological regressor describing the time course of activation within the seed region (the amygdala), and 3) an interaction term (ROI timecourse×[paroled−not paroled]). The seed ROI for this analysis was defined using the subject-specific amygdala masks described above. Time courses of activation for the ROI were defined by averaging the activation within the ROI for each volume within each of the six experimental runs, for each subject, resulting in one vector per run for each subject. The interaction term describes the differential functional connectivity across the two task conditions; the task and physiological regressor are included as covariates of no interest, such that the interaction term captures only that variance that is over and above that which is accounted for by the main effects (S6). Results for all analyses conducted here are presented on the standard MNI template brain image, as distributed within SPM.

Finally, multi-voxel pattern analyses were carried out on the (unsmoothed) fMRI data using the MATLAB routines provided in the Princeton MVPA Toolbox (www.csbmb.princeton.edu/mvpa). Briefly, for this analysis, the time series from each voxel was first de-trended and z-scored. Condition onsets were adjusted for the lag in BOLD signal response by shifting all block-onset timings by three volumes (6 s), and a sparse logistic regression algorithm (S7) was then used for classification, with decoding accuracy determined using a leave-one-out cross-validation method (S8). According to this procedure, the classifier was trained on five of the six experimental runs and tested on the sixth, thus taking into account only classification performance for data that had not been used to train the classifier. A spherical searchlight approach was used in order to examine activation patterns across the whole brain, while constraining their overall dimensionality by limiting the region within which any one classifier was developed (for a review of the searchlight approach to pattern analysis in fMRI data, see S9). We tested for significant differences from chance performance (50% correct) using Bonferroni-corrected one-sample one-sample t tests.

Experiment 4.

Data analysis for Experiment 4 followed the same procedure as described above for Experiment 2.

Experiment 5.

Data analysis for Experiment 5 followed the same procedure as described above for Experiment 2.

Experiment 6.

Data analysis for Experiment 5 followed the same procedure as described above for Experiment 2.

Experiment 7.

As in Experiment 3, post-scan explicit trustworthiness ratings were first analyzed in order to determine if the sample of participants used were comparable to those sampled in previous experiments reported here. After confirming that post-scan behavioral ratings of inmates' trustworthiness were again predictive of parole board decisions (β=0.130, p<0.001), we proceeded to analyze the functional neuroimaging data from the primary task.

Imaging data for Experiment 7 were pre-processed according to the same procedure described above for Experiment 3, including alignment to anatomical volumes, transformation to standard stereotactic space, Gaussian filtering, slice-time correction, and 3-dimensional motion correction. Preprocessed functional data for each participant were then fit to a generalized linear model, with an event-related design used to describe the onset timing and duration for each stimulus. Design matrices for each participant were fully factorial, describing the onset and duration of events as categorized with respect to both stimulus category (paroled vs. not paroled) and the agreement between this jury (consensus) categorization and the participant's idiosyncratic categorization (congruent; incongruent.)

Experiment 8.

Data analysis for Experiment 4 followed the same procedure as described above for Experiment 1, substituting the stimulus categories pleasant and unpleasant for the likely and unlikely (to be able one's parole without reoffending) response options.

TABLE S1
Group means differences and regression parameters
in trustworthiness judgments for paroled vs. non-paroled prisoners

| | Regression parameters | | | | | | | |
|---|---|---|---|---|---|---|---|---|
| | No crime | | Crime | | Group means | | Paired- | |
| | covariates | | covariates | | (trustworthiness) | | difference | |
| Experiment | β | p | β | p | M_{Paroled} | M_{Not-paroled} | t | p |

| 1 (French) | .113 | <.001 | .0566 | −.0575 | 4.993 | <.001 |
|---|---|---|---|---|---|---|
| 1 (English) | .057 | <.01 | .0541 | −.0541 | 5.720 | <.001 |
| 2 (balanced) | .109 | <.001 | .0293 | −.0290 | 2.570 | <.05 |
| 3 (dichot) | n/a | | .58 | .56 | 2.070 | <.05 |
| 4 (aff. prime) | n/a | | | | | |
| 5 (fMRI) | .107 | <.001 | .0529 | −.0529 | 4.504 | <.001 |
| 6 (fMRI 2) | .130 | <.001 | .0641 | −.0641 | 5.706 | <.001 |

| | |
|---|---|
| 6 (fMRI 2) | n/a |

Note:
Regression parameters were calculated from a GEE model fit according to the procedures outlined by ([citations]). Mean differences were analyzed using a paired student's t-test (paroled-no paroled). Group means expressed in standardized (Z) scores.

TABLE S2
Social trait ratings for prisoners, and their relationship
to parole application success.

| | | | 95% Confidence | | | |
|---|---|---|---|---|---|---|
| | | | interval | | | |
| | | | Lower | Upper | p | |
| Dimension | Nᵣₐₜₑᵣₛ | β | limit | limit | value | Component |
| Attractiveness | 92 | .107 | .066 | .147 | .000 | 1 |
| Charisma | 46 | .062 | .016 | .108 | .009 | 1 |
| Competence | 55 | .045 | −.009 | .098 | .101 | 1 |
| Dominance | 51 | −.011 | −.067 | .045 | .711 | 2 |
| Honesty | 48 | .045 | −.007 | .097 | .088 | 1 |
| Intelligence | 43 | .111 | .050 | .173 | .000 | 1 |
| Kindness | 44 | .022 | .025 | .069 | .361 | 1 |
| Leadership | 50 | .053 | −.013 | .118 | .119 | 1 |
| Likeability | 51 | .084 | .038 | 130 | .000 | 1 |
| Masculinity/ | 42 | .224 | .169 | .280 | .000 | 1 |
| Femininity | | | | | | |
| Trustworthiness | 128 | .057 | .022 | .092 | .005 | 1 |

Note:
Social trait dimensions along which naïve observers rated inmates, based on their pictures. Principal components analysis (PCA) with varimax rotation extracted two major components accounting for 46.7% of the variance across measures, the first of which was consistent with perceived “warmth”, and the other with perceived “dominance”.

TABLE S3

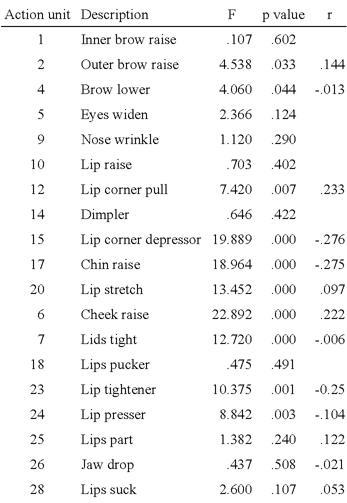

Note: Relationship between action units, as measured using the prisoners' identification photographs and Computer Emotion Recognition Toolbos, and mean perceived trustworthiness for each prisoners, as measured in a multiple linear regression. Analysis includes all 1576 prisoners for which identification pictures were availabe. Trustworthiness ratings obtained as described in Experiment 4. Pearson's r reported for action units with a significant relationship to perceived trustworthiness. Action units highlighted in gray are positively correlated with perceived trustworthiness. Action units highlighted in dark grey are inversely correlated with perceived trustworthiness.

TABLE S4
Peak activations (paroled > not paroled: implicit
judgment paradigm)

| | | | MNI | | | | |
|---|---|---|---|---|---|---|---|
| | | | coordinates | | | Z- | |
| Regions | Laterality | Cluster | x | y | z | score | k |
| Paroled > Not Paroled | | | | | | | |
| Fusiform gyrus | L/R | 1 | 22 | 35 | 32 | 4.51 | 22 |

| | |
|---|---|
| Not Paroled > Paroled | No suprathreshold activation |

Note:
Regions showing a significant main effect of parole status (implicit evaluation task). Stereotactic coordinates and t values are provided for local voxel maxima in the regions showing a significant main social context. (p < 0.05, FDR corrected).
Coordinates are defined in Montreal Neurologic Institute (MNI) stereotactic space in millimeters: x = 0 is right of the midsagittal plane, y = 0 is anterior to the anterior commissure, and z = 0 is superior to anterior commissure-posterior commissure plane.
L = left hemisphere,
R = right hemisphere.
Regions marked with the same superscript value belong to the same cluster.
k = cluster size. Reported peaks thresholded at k ≧ 10; Subpeaks more than 8 mm from the main peak in each cluster are listed.

TABLE S5
Peak activations (psychophysiological interaction:
amygdalar functional connectivity X prisoner condition -
paroled vs. not paroled)

| | | | MNI | | | | |
|---|---|---|---|---|---|---|---|
| | | | coordinates | | | Z- | |
| Regions | Laterality | Cluster | x | y | z | score | k |
| Amygdalar | | | | | | | |
| connectivity | | | | | | | |
| greater for | | | | | | | |
| paroled than | | | | | | | |
| not paroled | | | | | | | |
| prisoners | | | | | | | |
| Inferior occipital | R | 1 | 42 | −88 | −11 | 3.69 | 15 |
| gyrus | | | | | | | |
| Fusiform gyrus | R | 2 | 39 | −43 | −26 | 3.52 | 11 |
| V2 | L | 3 | −12 | −106 | −2 | 3.50 | 12 |
| V2 | L | 3 | −21 | −106 | −2 | 3.14 | |
| V2 | R | 4 | 24 | −103 | −5 | 3.36 | 13 |

Note:
Regions of differential functional connectivity with the (left) amygdala depending on prisoner condition (granted vs. denied parole by the prison board). Stereotactic coordinates and t values are provided for local voxel maxima in the regions showing a significant main social context, (p < 0.001).
Coordinates are defined in Montreal Neurologic Institute (MNI) stereotactic space in millimeters: x = 0 is right of the midsagittal plane, y = 0 is anterior to the anterior commissure, and z = 0 is superior to anterior commissure-posterior commissure plane.
L = left hemisphere;
R = right hemisphere.
k = cluster size. Reported peaks thresholded at k ≧ 10; Subpeaks more than 8 mm from the main peak in each cluster are listed.

TABLE S6
Peak activations (paroled > not paroled; explicit
judgment paradigm)

| | | | MNI | | | | |
|---|---|---|---|---|---|---|---|
| | | | coordinates | | | | |
| Regions | Laterality | Cluster | x | y | z | Z-score | k |
| Paroled > | | | | | | | |
| Not Paroled | | | | | | | |
| Fusiform gyrus | R | 1 | 30 | −52 | −17 | 3.40 | 51 |
| Fusiform gyrus | R | 1 | 27 | −43 | −20 | 3.01 | |
| Culmen | R | 2 | 6 | −52 | −23 | 3.24 | 12 |
| Culmen | L | 3 | −45 | −46 | −38 | 3.34 | 10 |
| Fusiform gyrus | L | 4 | −30 | −52 | −14 | 3.21 | 26 |
| Fusiform gyrus | L | 5 | −33 | −79 | −17 | 3.17 | 69 |

| | |
|---|---|
| Not Paroled > | No suprathreshold activation |
| Paroled | |

Note:
Regions showing a significant main effect of parole status (explicit evaluation task). Stereotactic coordinates and t values are provided for local voxel maxima in the regions showing a significant main social context. (p < 0.001).
Coordinates are defined in Montreal Neurologic Institute (MNI) stereotactic space in millimeters; x = 0 is right of the midsagittal plane, y = 0 is anterior to the anterior commissure, and z = 0 is superior to anterior commissure-posterior commissure plane.
L = left hemisphere;
R = right hemisphere.
k = cluster size. Reported peaks thresholded at k ≧ 10; Subpeaks more than 8 mm from the main peak in each cluster are listed.

TABLE S7
Peak activations (participant decision to grant parole
> participant decision to deny parole)

| | | | MNI | | | | |
|---|---|---|---|---|---|---|---|
| | | | coordinates | | | Z- | |
| Regions | Laterality | Cluster | x | y | z | score | k |
| Grant parole > | | | | | | | |
| Deny parole | | | | | | | |
| vmPFC | L | 1 | −9 | 26 | −14 | 3.96 | 46 |
| vmPFC | M | 1 | 0 | 20 | −11 | 3.28 | |
| MTG | L | 3 | −51 | −25 | −2 | 3.37 | 10 |

| | |
|---|---|
| Deny parole > | No suprathreshold activation |
| Grant parole | |

Note: Regions showing a significant main effect of individual's decision to grant versus deny parole to a target person (explicit evaluation task). Stereotactic coordinates and t values are provided for local voxel maxima in the regions showing a significant main social context. (p<0.001). Coordinates are defined in Montreal Neurologic Institute (MNI) stereotactic space in millimeters: x=0 is right of the midsagittal plane, y=0 is anterior to the anterior commissure, and z=0 is superior to anterior commissure-posterior commissure plane. L=left hemisphere; R=right hemisphere; M=medial. k=cluster size. Reported peaks thresholded at k≧10; Subpeaks more than 8 mm from the main peak in each cluster are listed.

TABLE S8
Peak activations (congruent with jury > incongruent with jury)

| | | | MNI | | | | |
|---|---|---|---|---|---|---|---|
| | | | coordinates | | | | |
| Regions | Laterality | Cluster | x | y | z | Z-score | k |
| Correct > | | | | | | | |
| Incorrect | | | | | | | |
| dIPFC | R | 1 | 36 | 20 | 19 | 4.08 | 145 |
| Caudate | R | 1 | 21 | 17 | 22 | 3.53 | |
| body | | | | | | | |
| dIPFC | R | 1 | 42 | 11 | 19 | 2.91 | |
| SMA | R | 2 | 9 | 50 | 46 | 3.73 | 156 |
| dmPFC | L | 2 | −12 | 59 | 34 | 3.47 | |
| dmPFC | L | 2 | −12 | 50 | 28 | 3.25 | |
| Cerebellum | L | 3 | −18 | −55 | −50 | 3.53 | 36 |
| vIPFC | R | 4 | 30 | 35 | 7 | 3.50 | 12 |
| Lentiform | L | 5 | −18 | −10 | −8 | 3.42 | 21 |
| nucleus | | | | | | | |
| STG | R | 6 | 48 | −19 | −2 | 3.35 | 24 |
| Medal | R | 6 | 39 | −15 | −11 | 2.75 | |
| temporal | | | | | | | |
| lobe | | | | | | | |
| Lentiform | R | 7 | 27 | 2 | −2 | 3.27 | 52 |
| nucleus | | | | | | | |
| SMA | L | 8 | −12 | 35 | 52 | 3.23 | 30 |
| Caudate | L | 9 | −15 | 11 | 25 | 3.16 | 12 |
| body | | | | | | | |
| vIPFC | L | 10 | −57 | 17 | 1 | 3.12 | 16 |
| vIPFC | L | 10 | −51 | 25 | −2 | 2.71 | |
| dIPFC | R | 11 | 30 | 14 | 49 | 3.08 | 11 |
| mPFC | L | 12 | −21 | 38 | −14 | 3.03 | 17 |
| Precuneus | L | 13 | −12 | −43 | 67 | 2.89 | 10 |
| Precuneus | R | 14 | 27 | −61 | 52 | 2.88 | 17 |

| | |
|---|---|
| Incorrect > | No suprathreshold activation |
| Correct | |

Note:
Regions showing a significant main effect of consensus - i.e. where individuals' idiosyncratic judgments were the same as those made by the parole board (explicit evaluation task), Stereotactic coordinates and t values are provided for local voxel maxima in the regions showing a significant main social context. (p < 0.001).
Coordinates are defined in Montreal Neurologic Institute (MNI) stereotactic space in millimeters: x = 0 is right of the midsagittal plane, y = 0 is anterior to the anterior commissure, and z = 0 is superior to anterior commissure-posterior commissure plane.
L = left hemisphere;
R = right hemisphere.
Regions marked with the same superscript value belong to the same cluster.
k = cluster size. Reported peaks thresholded at k ≧ 10; Subpeaks more than 8 mm from the main peak in each cluster are listed.

TABLE S9
Peak activations (interaction; participant decision x
jury decision)

| | | | MNI coordinates | | | | |
|---|---|---|---|---|---|---|---|
| Regions | Laterality | Cluster | x | y | z | Z-score | k |

Note:
Regions showing a significant interaction effect (participant decision x jury decision). Stereotactic coordinates and t values are provided for local voxel maxima in the regions showing a significant main social context. (p < 0.001).
Coordinates are defined in Montreal Neurologic Institute (MNI) stereotactic space in millimeters: x = 0 is right of the midsagittal plane, y = 0 is anterior to the anterior commissure; and z = 0 is superior to anterior commissure-posterior commissure plane.
L = left hemisphere;
R = right hemisphere.
Regions marked with the same superscript value belong to the same cluster.
k = cluster size. Reported peaks thresholded at k ≧ 10; Subpeaks more than 8 mm from the main peak in each cluster are listed.

Referring specifically to the figures, FIGS. 5A-E (A) Experimental paradigm for Experiment 1. Participants were informed that the pictures they would see were of inmates who would soon be eligible for parole, and asked to indicate—as quickly and as accurately as possible—how likely they thought it was that each person would be able to successfully complete his or her parole. Arrangement of the choice alternatives (“likely”; “unlikely”) was counterbalanced across participants. (B) Results revealed significant differences in both the nature and response latency of participants' responses for those inmates who were eventually granted parole versus those whose applications were denied. (C) Experimental setup for social rating task. Stimuli were displayed until trustworthiness selections were made; directionality of VAS scale was counterbalanced across participants. (D) Average trustworthiness ratings for paroled versus non-paroled inmates. On the left are results from a representative sample (N=1,687) of all inmates eligible for parole between August and October, 2012. On the right are results from two judgment studies using a pseudo-randomly selected gender and race-balanced subset of inmates (N=128). In all cases, ratings are z-scored, so as to eliminate the influence of individual differences in general tendency to trust and allow for better cross-study comparison; non-scored means and statistics are available in supplementary materials. (E) Simulated Bernoulli distribution describing the relationship between perceived trustworthiness and inmates' likelihood of parole, all other factors notwithstanding. The probability of parole on each trial is defined by a logistic regression model with the parameters estimated from 1 the data in Experiment 1.

FIG. 6A-D shows results from the first functional neuroimaging study, examining implicit social evaluations. (A) Experimental paradigm for neuroimaging study examining implicit evaluations. Participants completed a standard “1-back” task—in which their goal was to press a response button as quickly as possible when they detected the same photograph twice in a row—while functional neuroimaging data were collected. (B) Results of neuroimaging study examining implicit evaluations. Significantly greater activation in both striate and extrastriate cortex was detected in response to photographs of inmates whose applications for parole were granted than for prisoners whose applications were denied. (C) Schematic depicting hypothesized modulatory effect of amygdala activation on stimulus representation within occipitotemporal cortices. (D) Regions in which there was a significant interaction between amygdalar functional connectivity, and the experimental condition (paroled vs. not paroled inmates).

FIG. 7A-C shows results from the second functional neuroimaging study, examining explicit social evaluations. (A) Regions responding to the consensus value. (B) Regions responding to idiosyncratic value. (C) Regions responding to the confluence (or lack thereof) of consensus and idiosyncratic value. Cluster size and stereotactic coordinates for the results reported here can be found in supplementary materials (Tables S5-8). FIG. 8A-C Is the Affective misattribution paradigm for Experiment 6.

FIG. 9A-B shows experimental paradigm for Experiment 5. Participants completed two different tasks while functional imaging data were collected: (A) The first was a standard 1-back task, in which participants were shown a series of images (prison photographs) and their goal was to respond as quickly as possible when the same image was presented twice in a row. Participants completed. During the second part of the experiment, participants completed a similar task, but this time using images of faces, houses, and black and white geometric patterns (B). FIG. 11 shows action units identified as having a significant relationship to perceived trustworthiness (see Table S3).

Although the above experiments have been described as to perceptions of trustworthiness, the methodology employed can be used to identify other types of perceptions and it is understood that the description herein provides but one of many examples of how perceptions can be analyzed and predicted. It is also understood that although the experiments have been described as to facial feature, other visual features can be analyzed. For example, broad shoulders, shrugged shoulders, crossed arms, clenched fists and these visual features can be identified by tracking eye movements as described herein.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for relating visual features to a perception by an observer of subjects having the same or similar features, the method comprising:
providing a computer in communication with a display, a response device, an imaging device and a storage;
displaying at least a first one of a plurality of images via the display to a viewer, each image corresponding to one of a plurality of subjects;
receiving a response via a response device from the viewer to the at least a first one of the plurality of images wherein the response is indicative of at least a first or a second response to the at least a first one of the plurality of images;
recording via the imaging device at least one focus region of the viewer on the displayed image and correlating the at least one focus region with a visual feature of the subject;
generating a data set via the computer and storing said data set on said storage, the data set creating an association between the visual feature and the response to indicate a likely perception based on the visual feature.

2. The method of claim 1 wherein the association is a statistical correlation.

3. The method of claim 1 wherein the visual features are facial features of the subject.

4. The method of claim 1 wherein the imaging device determines the at least one focus region by tracking eye movement of the viewer between initial display of each image and receipt of the response and associating the eye movement with at least one location for each of the plurality of images.

5. The method of claim 1 further comprising:
providing a neuro-imaging scanner in communication with the computer and transmitting neuro-imaging data of the viewer, the neuro-imaging data indicative of a neurological response of the viewer between initial display of the at least a first one of the plurality of images and receipt of the response;
said step of generating the data set further including associating the neurological response with the focus region and the visual feature.

6. The method of claim 1 wherein the first response is indicative of a positive perception and the second response is indicative of a negative perception.

7. The method of claim 1 wherein the first response is selected from the group consisting of: trustworthy, honest, focused, strong, creative, and combinations thereof and the second response is a negative of the first response.

8. The method of claim 1 further comprising repeating the displaying, receiving and recording steps for successive ones of the plurality of images and wherein the generating associates the visual feature with the likely perception based on a statistical correlation of the responses to the successive ones of the plurality of images to generate the data set.

9. A system for determining a likely perception of a subject based on an image of the subject, the system comprising:
a computer in communication with a storage, the storage having data stored thereon, the data providing an association between at least one visual feature and a perception;
software executing on said computer and receiving at least one image of the subject and further determining at least one subject feature by comparing the at least one image to the at least one visual feature, said software associating the at least one subject feature with the at least one visual feature based on a match where the match is indicative of the at least one subject feature matching the at least one visual feature;
a display coupled to the computer and presenting the perception associated with the at least one visual feature based on the at least one subject facial feature being associated therewith.

10. The system of claim 9 wherein the visual feature and the at least one feature are both facial features.

11. The system of claim 9 wherein the perception presented via the display is indicative of a likelihood that a third party viewing the at least one image would have the perception upon viewing the at least one image.

12. The system of claim 9 wherein the at least one subject feature is determined by identification of an area of the at least one image corresponding to a face and comparing parts of the area to known images corresponding to control features, where the parts of the area are matched to the control features that are associated with control images and the parts of the area are matched based on a coloring or shape or combinations thereof to determine the match.

13. The system of claim 12 wherein the parts of the area are matched to the control features based on a percentage of similarity or a percentage in relation to two control features having different intensity of the control features to determine the match.

14. The system of claim 9 wherein the match between the at least one visual feature and the at least one subject feature is expressed as a similarity.

15. The system of claim 9 wherein the similarity is a percentage.

16. A system for selecting one or more images based on a desired perception, the system comprising:
a computer in communication with a storage, the storage having data stored thereon, the data indicative of an association between at least one visual feature and a perception;
software executing on said computer and receiving a plurality of images of a subject and a selection of a selected perception;
said software further determining at least one subject feature for each of the plurality of images and associating at least one subject feature with the at least one visual feature to determine a perception for one or more of the plurality of images;
said software further determining which of the one or more of the plurality of images is most likely to be associated with the selected perception to determine at least one likely image;
a display coupled to the computer and presenting the at least one likely image.

17. The system of claim 16 wherein the at least one likely image is a ranking of multiple images.

18. The system of claim 16 wherein the at least one likely image is presented as the group consisting of: an image, file name, file path, or combinations thereof, that is most likely to be associated with the selected perception.

19. The system of claim 16 wherein the association between the visual feature and the perception is based on a set of data gathered by displaying a plurality of images to a plurality of viewers wherein upon display of each of the plurality of images, one of the plurality of viewers indicates at least a first or second response, the response associated with an initial perception and said data correlates a plurality of responses to the plurality of images with focus region such that the focus region is associated with the visual feature.

20. A system for producing an image associated with likely perceptions, the system comprising:
a computer in communication with a storage having data stored thereon, the data associating a visual feature of a subject with a perception;
software executing on said computer for receiving a selected perception;
said software receiving a plurality of images and determining at least two perceptions associated with each image based on two visual features;
said software selecting a first one of the plurality of images having the selected perception as the most likely perception among the plurality of images based on a first one of the two visual features;
said software comparing a second one of the two visual features to the selected perception to determine if the second one of the two visual features conflicts or undermines the selected perception such that the selected perception is less likely;
said software selecting part of at least one of the plurality of images, where the part of the at least one of the plurality of images increases the likelihood of the selected perception;
said software overlaying the part of the at least one of the plurality of images over a part of the first one of the plurality of images to create a combined image.

21. The system of claim 20 further comprising:
said software blending the part of the at least one of the plurality of images with the first one of the plurality of images by modifying a color or a shading or a lighting effect of the combined image to increase the likelihood of the selected perception.

22. A method for relating content features to a perception by an observer of subjects having the same or similar content features, the method comprising:
providing a computer in communication with a presentation device, a response device, and a storage;
presenting a first one of a plurality of content segments via the presentation device to a responder, each content segment corresponding to one of a plurality of subjects;
receiving a response via a response device from the responder to the at least a first one of the plurality of content segments the response is indicative of a degree to which the responder perceives a specified perception;
repeating the presenting and receiving steps for each of the plurality of content segments;
generating a dataset associating each of the plurality of content segments with the responder's response;
identifying a pattern based on the dataset to associate a feature of the plurality of content segments with the specified perception;
comparing the feature with a user content segment to determine the likelihood of the specified perception for the user content segment based on the dataset.

23. The method of claim 22 wherein the plurality of content segments are selected from the group consisting of an: image, sound, video or combinations thereof.
